(19) United States
(12) Patent Application Publication
(10) Pub. No.: US 2024/0272426 A1
(43) Pub. Date: Aug. 15, 2024

(54) METALENS AND METALENS ARRAY WITH EXTENDED DEPTH-OF-VIEW AND BOUNDED ANGULAR FIELD-OF-VIEW

(71) Applicant: The Regents of the University of California, Oakland, CA (US)

(72) Inventors: Weijian Yang, Redwood City, CA (US); Junjie Hu, Davis, CA (US)

(73) Assignee: The Regents of the University of California, Oakland, CA (US)

(21) Appl. No.: 18/569,400

(22) PCT Filed: Jul. 7, 2022
(86) PCT No.: PCT/US2022/036376

§ 371 Date: Dec. 12, 2023

Related U.S. Application Data
(63) Continuation-in-part of application No. PCT/US22/16237, filed on Feb. 11, 2022.
(60) Provisional application No. 63/149,034, filed on Feb. 12, 2021.
(60) Provisional application No. 63/219,121, filed on Jul. 7, 2021.

(51) Int. Cl. G02B 27/00; G02B 1/00; G02B 5/00

(52) U.S. Cl. CPC G02B 27/0075; G02B 1/002; G02B 5/001

(57) ABSTRACT

A metalens array for three-dimensional (3D) imaging is disclosed. This metalens array includes an array of metalens units. Each metalens unit in the array is configured with an extended depth of view (DOV) for projecting a cluster of object sources positioned in a range of object distances in the axial direction into a cluster of image spots in an image plane such that each of the image spots remains in focus and is separated from other image spots in the cluster of image spots. Moreover, the metalens array is configured to project the cluster of object sources into multiple clusters of image spots in the image plane, wherein each cluster of image spots is a different copy of the cluster of object sources in the image plane located apart from other clusters of image spots.

### CROSS-REFERENCE TO RELATED APPLICATION

This patent application is a continuation-in-part of, and hereby claims priority to International Application No. PCT/US2022/016237, filed 11 Feb. 2022 (Attorney Docket No. UC21-677-2PCT), which claims the benefit of U.S. Provisional Patent Application No. 63/149,034, filed 12 Feb. 2021 (Attorney Docket Number UC21-677-1PSP). This patent application also claims priority to U.S. Provisional Patent Application No. 63/219,121, filed 7 Jul. 2021 (Attorney Docket No. UC21-925-1PSP). The preceding patent application and provisional patent applications are hereby incorporated by reference as a part of this application.

### GOVERNMENT LICENSE RIGHTS

This invention was made with U.S. government support under grant number R21EY029472 awarded by the National Institutes of Health (NIH). The U.S. government has certain rights in the invention.

### BACKGROUND

### Field

The disclosed embodiments generally relate to optical imaging devices and techniques. More specifically, the disclosed embodiments relate to the designs of metasurfaces, metalenses and metalens arrays with angular-dependent field-of-view for two-dimensional (2D) and for three-dimensional (3D) imaging applications.

### Related Art

Metasurfaces are a novel photonic devices that have distinct optical properties. A metasurface is generally composed of a thin substrate supporting an array of artificially-designed nanostructures, which are also referred to as meta-units. Metasurfaces have been gaining popularity for constructing optical modules because of their design flexibilities and numerous potential applications. The applications of metasurfaces include polarizer, holography, hyperspectral imaging, and high-resolution imaging, among others. Although metasurfaces are ideal for building compact optical systems and devices, existing metasurface-based optical devices typically have constraints on allowable field-of-view to control geometric aberrations and crosstalk in the image plane. This limits the potential of metasurfaces in large field-of-view applications.

Hence, what are needed are meta-unit and metasurface designs for constructing optical modules without the drawbacks of existing devices and techniques.

### SUMMARY

This disclosure provides meta-unit and metasurface designs that enable angular-dependent transmissions or reflections of meta-units and metasurfaces. In various embodiments, meta-units and metasurfaces with angular-dependent transmissions or reflections are used to construct metalenses with bounded angular field-of-views (FOVs). The disclosed metalens with bounded angular FOV can then be tiled into a metalens array to extend the overall angular and linear FOVs. The disclosed metalens arrays with both bounded local FOVs and large overall FOVs can be used in compact imaging systems to perform large FOV two-dimensional (2D) imaging and three-dimensional (3D) imaging. In various embodiments, meta-units and metasurfaces with angular-dependent transmissions or reflections are also used to construct metasurface angular filters. The disclosed metalenses arrays and metasurface angular filters can also be used in miniaturized imaging devices, light-field cameras, compact cameras, endoscopy, biomedical imaging, consumer electronics, surveillance systems, among others.

Note that existing metasurface designs and applications neither specifically pay attention to angular-dependent transmission intensity and phase of the metasurface, nor the angular-dependent reflection intensity and phase of the metasurface. This disclosure provides metasurface designs that effectuate angular-dependent transmission or reflection intensity. Meanwhile, within the high transmission intensity or high reflection intensity region, the disclosed metasurface designs can also achieve a nearly angular-independent transmission phase shift or reflection phase shift. For example, when a plane wave is used to illuminate the disclosed metasurface, the transmission or reflection intensity will drop rapidly once the angle of incidence is greater than a particular cutoff angle. However, when the angle of incidence is smaller than the cutoff angle, the transmission light or reflection light will experience nearly the same amount of phase change for different angles of incidence. A disclosed metasurface having the above transmission or reflection properties can be used to construct a metalens with a bounded FOV, a metalens array with bounded local FOVs for compact imaging systems that can perform large FOV 2D imaging, a metalens array for compact imaging systems that can perform a large FOV 3D imaging, and metasurface angular filters.

In various embodiments, a procedure of designing a metasurface with angular-dependent transmission or reflection intensity is provided. The design procedure may start with the simulation of a periodic arrangement of identical meta-units. In the simulation process, multiple design parameters of a meta-unit can be explored, wherein these design parameters can include but are not limited to, the geometry of a nanostructure within the meta-unit (e.g., the shape, the diameter if the nanostructure has a circular cross-section, the length if the nanostructure is a rectangle, the thickness/height of the nanostructure, etc.), refractive index of the nanostructure material, refractive index of the substrate of the meta-unit, refractive index of the superstrate of the meta-unit, and the periodicity of the meta-units. Note that the nanostructure within the meta-unit can be nano-posts or nanoholes, and can have different geometries including but not limited to, circle, ellipse, square, rectangle, triangular, star, among others.

In one aspect, a metalens array for 3D imaging is disclosed. This metalens array includes an array of metalens units. Each metalens unit in the array is configured with an extended depth of view (DOV) for projecting a cluster of object sources positioned in a range of object distances in the axial direction into a cluster of image spots in an image plane such that each of the image spots remains in focus and is separated from other image spots in the cluster of image spots. Moreover, the metalens array is configured to project the cluster of object sources into multiple clusters of image spots in the image plane, wherein each cluster of image spots is a different copy of the cluster of object sources in the image plane located apart from other clusters of image spots.

In some embodiments, each metalens unit in the metalens array is configured with a phase-shift profile to effectuate a Bessel beam point spread function (PSF) in the image plane for each object source in an object plane within the extended DOV.

In some embodiments, each metalens unit further includes: (1) a substrate support; and (2) an axicon structure disposed on the substrate support to effectuate the Bessel beam PSF for a given object source.

In some embodiments, each metalens unit further includes: (1) a substrate support; and (2) a 2D array of nanostructures disposed on the substrate support to effectuate a spatial phase-shift profile that resembles an axicon.

In some embodiments, each metalens unit in the metalens array includes a phase-shift mask to effectuate a double-helix PSF in the image plane for each object source in an object plane within the extended DOV.

In some embodiments, each metalens unit in the metalens array includes a phase-shift mask to effectuate a cubic phase PSF in the image plane for each object source in an object plane within the extended DOV.

In some embodiments, the metalens array is configured to allow only a predetermined number of metalens units within the metalens array to image an object point source into the predetermined number of image spots in the image plane. Note that this predetermined number is less than the number of metalens units in the metalens array, thereby limiting the total number of images of the object point source in the image plane.

In some embodiments, the total number of clusters in the multiple clusters of image spots equals the predetermined number.

In some embodiments, the predetermined number is between 4 and 9.

In some embodiments, the predetermined number of metalens units includes either 2×2 metalens units or 3×3 metalens units.

In some embodiments, each metalens unit within the metalens array units is configured with a bounded angular field of view (FOV) such that the metalens unit operates to pass an incident light emitted inside the bounded angular FOV of the metalens unit and reject an incident light beyond the bounded angular FOV of the metalens unit.

In some embodiments, the metalens array has an overall two-dimensional (2D) FOV in an object plane determined by the sum of individual bounded angular FOVs associated with the individual metalens units in the metalens array.

In some embodiments, the metalens array has a depth of view (DOV) in the axial direction that equals the extended DOV of the individual metalens units in the metalens array.

In some embodiments, the array of metalens units includes M×N metalens units, wherein M≠N.

In another aspect, a metalens unit for three-dimensional (3D) imaging is disclosed. This metalens unit is configured with an extended depth of view (DOV) for projecting a cluster of object sources positioned in a range of object distances in the axial direction into a cluster of image spots in an image plane such that each of the image spots remains in focus and is separated from other image spots in the cluster of image spots. Moreover, the metalens unit is also configured with a bounded angular field of view (FOV) such that the metalens unit operates to pass an incident light emitted inside the bounded angular FOV of the metalens unit and reject an incident light beyond the bounded angular FOV of the metalens unit.

In some embodiments, the metalens unit is configured with a phase-shift profile to effectuate a Bessel beam point spread function (PSF) in the image plane for each object source in an object plane within the extended DOV.

In some embodiments, the metalens unit is composed of a substrate support and a 2D array of nanostructures disposed on the substrate support to effectuate a phase-shift profile that resembles an axicon.

In some embodiments, the metalens unit includes a phase-shift mask to effectuate a double-helix PSF in the image plane for each object source in an object plane within the extended DOV.

In some embodiments, the metalens unit includes a phase-shift mask to effectuate a cubic phase PSF in the image plane for each object source in an object plane within the extended DOV.

In yet another aspect, a metalens array for large FOV 3D imaging is disclosed. This metalens array includes an array of metalens units. Each metalens unit in the array is configured with an extended depth of view (DOV) for projecting a cluster of object sources positioned in a range of object distances in the axial direction into a cluster of image spots in an image plane such that each of the image spots remains in focus and is separated from other image spots in the cluster of image spots. Moreover, each metalens unit in the array is further configured with a bounded angular field of view (FOV) such that the metalens unit operates to pass an incident light emitted inside a predetermined cutoff angle of the bounded angular FOV and reject an incident light beyond the predetermined cutoff angle of the bounded angular FOV. When used in a 3D imaging system, the metalens array generates only a predetermined number of copies of images for each object point source in an image plane.

In some embodiments, the predetermined number is between 4 and 9.

In some embodiments, the predetermined number is less than the number of metalens units in the metalens array, thereby limiting the total number of images of the object point source in the image plane.

In some embodiments, the metalens array has an overall two-dimensional (2D) FOV in an object plane determined by the sum of individual bounded angular FOVs associated with the individual metalens units in the metalens array.

In some embodiments, the array of metalens units includes M×N metalens units, wherein M≠N.

In some embodiments, the array of metalens units includes M×N metalens units, wherein M=N.

In still another aspect, a system for imaging and resolving objects in a three-dimension (3D) space is disclosed. This system projects, via a metalens array, a cluster of object sources within a 3D volume having different object distances in the axial direction of the metalens array into multiple clusters of image spots in an image plane of the metalens array. Note that each cluster of image spots is a different copy of the cluster of object sources in the image plane located apart from other clusters of image spots in the image plane, and the metalens array is configured with an extended depth of view (DOV) so that each image spot within each cluster of image spots remains in focus and is separated from other image spots in the cluster of image spots. The system then processes, using one or more processors the multiple clusters of image spots using a ray-tracing technique to correlate each image spot in the multiple clusters of image spots to an object source in the cluster of object sources.

In some embodiments, system uses the ray-tracing technique to resolve two object sources having different Z-distances in the axial direction but similar in-plane positions by applying a scaling rule that: (1) an object point source having a greater Z distance in the axial direction is projected onto the image plane closer to the center of the image plane; and (2) an object point source having a smaller Z distance in the axial direction is projected onto the image plane further away from the center of the image plane.

In some embodiments, system uses the ray-tracing technique to resolve two object sources having different in-plane positions but similar Z-distances in the axial direction by applying a translation rule to each copy of image spots of the two object sources in the multiple clusters of image spots.

### BRIEF DESCRIPTION OF THE FIGURES

FIG. 1A illustrates the side-view of an exemplary metalens in accordance with the disclosed embodiments.

FIG. 1B illustrates the zoom-in view of a portion of the exemplary metalens in FIG. 1A highlighting a single meta-unit, in accordance with the disclosed embodiments.

FIG. 1C illustrates the top view of the exemplary metalens in FIG. 1A in accordance with the disclosed embodiments.

FIG. 2A shows a conventional metalens design that does not have a bounded angular FOV.

FIG. 2B shows a proposed metalens design having a bounding angular FOV in accordance with the disclosed embodiments.

FIG. 2C shows an exemplary transmission-coefficient profile T(θ) with a cutoff angle θ_{C} in accordance with the disclosed embodiments.

FIG. 3 presents a flowchart illustrating a process of designing a metalens that has a bounded angular FOV, in accordance with the disclosed embodiments.

FIG. 4 illustrates an exemplary use case of the disclosed metalens for high resolution 2D imaging in accordance with the disclosed embodiments.

FIG. 5A shows imaging quality degradation associated with a conventional metalens having a large numerical aperture (N.A.) when the paraxial condition is no longer valid.

FIG. 5B shows the side-view of a conventional metalens array that is composed of multiple small N.A. metalenses in each dimension.

FIG. 5C shows a metalens array wherein the metalens units are divided by physical barriers to control light sources with large incident angles.

FIG. 6A shows a single metalens having a bounded angular FOV and a bounded linear FOV in an object plane, in accordance with the disclosed embodiments.

FIG. 6B shows a side-view of a disclosed metalens array based on the metalens having a bounded angular FOV to achieve a large FOV while mitigating crosstalk between neighboring metalens units, in accordance with the disclosed embodiments.

FIG. 6C shows the use of the disclosed metalens array to achieve both bounded local FOV for image crosstalk reduction and a large overall FOV in an object plane, in accordance with the disclosed embodiments.

FIG. 7A shows an exemplary technique of calibrating the design of metalens units within a disclosed metalens array by matching the lens N.A. with the bounded angular FOV, in accordance with the disclosed embodiments.

FIG. 7B shows an alternative design of the metalens units within the disclosed metalens array by matching the lens N.A., with the bounded angular FOV in accordance with the disclosed embodiments.

FIG. 8A shows a compact camera system constructed by directly integrating a disclosed metalens array with an image sensor in accordance with the disclosed embodiments.

FIG. 8B shows a flexible camera system constructed by coupling a disclosed metalens array to an image sensor through a fiber bundle in accordance with the disclosed embodiments.

FIG. 9A shows a 3D representation and filtering operation of a disclosed metasurface angular filter in accordance with the disclosed embodiments.

FIG. 9B shows a 2D side-view and a first type of filtering operation of the disclosed metasurface angular filter in accordance with the disclosed embodiments.

FIG. 9C shows the same 2D side-view but the second type of filtering operation of the disclosed metasurface angular filter in accordance with the disclosed embodiments

FIG. 10A shows the concept of designing a metalens unit having a proper angular FOV and cutoff angle for use in a metalens array for 3D imaging, in accordance with the disclosed embodiments.

FIG. 10B shows a side-view of a disclosed metalens array constructed based on the metalens in FIG. 10A for 3D imaging, in accordance with the disclosed embodiments.

FIG. 11A shows an exemplary spatial profile of an axicon both in a schematic view and a realistic 3D view in accordance with the disclosed embodiments.

FIG. 11B shows an exemplary phase profile of a meta-axicon that is designed for 3D imaging applications to effectuate the extended/large depth-of-view (DOV) in accordance with the disclosed embodiments.

FIG. 12A shows using an exemplary single metalens configured with Bessel beam PSF to image a 3D object composed of multiple object point sources in accordance with the disclosed embodiments.

FIG. 12B shows the concept of resolving the multiple object point sources in FIG. 12A using an exemplary metalens array having an extended/large DOV in accordance with the disclosed embodiments.

FIG. 13 shows exemplary transmission-coefficient profiles T(θ) and the corresponding cutoff angles for 2D imaging applications and 3D imaging applications on the same plot in accordance with the disclosed embodiments.

FIG. 14 shows an exemplary 3D imaging application of the disclosed metalens array having the extended DOV in an endoscope imaging system in accordance with the disclosed embodiments.

FIG. 15 shows an exemplary application of the disclosed metalens array in a metalens-based microscopy for imaging SARS-CoV2 in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Terminology

Throughout this patent disclosure, the terms “transmission coefficient” and “transmission intensity” are used interchangeably as a measure of how much of an incident light wave passes through an optical element.

### Overview

This disclosure provides meta-unit and metasurface designs that enable angular-dependent transmissions or reflections of meta-units and metasurfaces. In various embodiments, meta-units and metasurfaces with angular-dependent transmissions or reflections are used to construct metalenses with bounded angular field-of-views (FOVs). The disclosed metalens with bounded angular FOV can then be tiled into a metalens array to extend the overall angular and linear FOVs. The disclosed metalens arrays with both bounded local FOVs and large overall FOVs can be used in compact imaging systems to perform large FOV two-dimensional (2D) imaging. In various embodiments, meta-units and metasurfaces with angular-dependent transmissions or reflections are also used to construct metasurface angular filters. The disclosed metalenses arrays and metasurface angular filters can also be used in miniaturized imaging devices, light-field cameras, compact cameras, endoscopy, biomedical imaging, consumer electronics, and surveillance systems, among others.

Note that existing metasurface designs and applications neither specifically pay attention to angular-dependent transmission intensity and phase of the metasurface, nor the angular-dependent reflection intensity and phase of the metasurface. This disclosure provides metasurface designs that effectuate angular-dependent transmission or reflection intensity. Meanwhile, within the high transmission intensity or high reflection intensity region, the disclosed metasurface designs can also achieve a nearly angular-independent transmission phase shift or reflection phase shift. For example, when a plane wave is used to illuminate the disclosed metasurface, the transmission or reflection intensity will drop rapidly once the angle of incidence is greater than a particular cutoff angle. However, when the angle of incidence is smaller than the cutoff angle, the transmission light or reflection light will experience nearly the same amount of phase change for different angles of incidence. A disclosed metasurface having the above transmission or reflection properties can be used to construct a metalens with a bounded FOV, a metalens array with bounded local FOVs for compact imaging systems that can perform large FOV 2D imaging, a metalens array for compact imaging systems that can perform a large FOV 3D imaging, and metasurface angular filters.

In various embodiments, a procedure of designing a metasurface with angular-dependent transmission or reflection intensity is provided. The design procedure may start with the simulation of a periodic arrangement of identical meta-units. In the simulation process, multiple design parameters of a meta-unit can be explored, wherein these design parameters can include but are not limited to, the geometry of a nanostructure within the meta-unit (e.g., the shape, the diameter if the nanostructure has a circular cross-section, the length if the nanostructure is a rectangle, the thickness/height of the nanostructure, etc.), refractive index of the nanostructure material, refractive index of the substrate of the meta-unit, refractive index of the superstrate of the meta-unit, and the periodicity of the meta-units. Note that the nanostructure within the meta-unit can be nano-posts or nanoholes, and can have different geometries including but not limited to, circle, ellipse, square, rectangle, triangular, star, among others.

During the design simulation, the above design parameters of the meta-unit and the incident angles of an illumination light are swept, and the phases (e.g., in terms of a retardance) and intensities of both the transmitted and reflected light for a specific light wavelength and polarization are computed and collected. Eventually, a database of transmission/reflection phase and intensity versus meta-unit design parameters and light incident angles is obtained. The design procedure can then select from the database those meta-unit configurations that have a desirable cutoff angle for a specific application. The design procedure can then be extended to construct a metalens based on the selected meta-unit configurations having substantially identical bounded angular FOV but different phase transformation properties. More specifically, a metalens can be constructed using the selected meta-unit configurations by arranging meta-units of different geometric configurations within a metasurface in a specific manner, so that the arranged meta-unit array effectuates the specific spatial phase profile of a targeted optical lens, such as a convex lens, a concave lens, or a deflector, among others.

Meta-Unit, Metasurface and Metalens with Bounded Angular Field-of-View

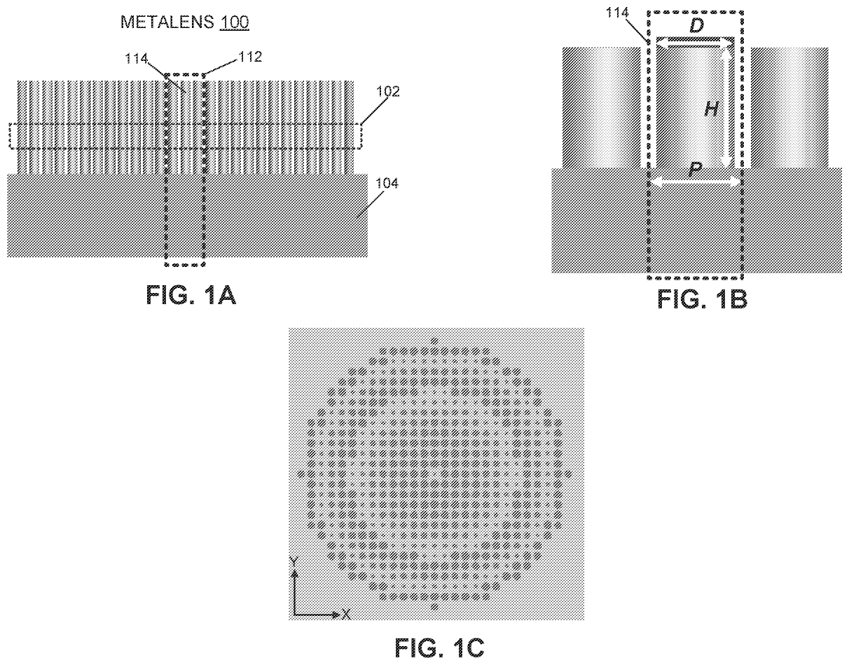

One main application of a metasurface configured with an angular-dependent transmission coefficient is for constructing a metalens with bounded angular field of view (FOV). FIG. 1A is a side-view of an exemplary metalens 100 in accordance with the disclosed embodiments. As can be seen in FIG. 1A, metalens 100 is composed of a group of densely-packed nanoposts 102 made of a first type of dielectric material (e.g., silicon) disposed on top of a substrate layer 104 of a second type of dielectric material (e.g., silicon dioxide). In various embodiments, nanoposts 102 are arranged on a two-dimensional (2D) periodic grid of unit cells (also referred to as the “meta-units”), wherein each nanopost in nanoposts 102 is positioned inside a given meta-unit in the 2D periodic grid. Note that the 2D periodic grid can be configured with the same period in both dimensions so that all meta-units have the same square shape and size. For example, the meta-units in metalens 100 can have a size in the order of 100 nm (i.e., —0.1 μm) to 1000 nm (i.e., ˜1 μm) in both dimensions. Hence, to construct a metalens with an area of a few mm², thousands of such periods/meta-units in each dimension of metalens 100 would typically be needed.

FIG. 1B is a zoom-in view of a portion 112 of the exemplary metalens 100 in FIG. 1A highlighting a single meta-unit 114, in accordance with the disclosed embodiments. As can be seen in FIG. 1B, meta-unit 114 in the exemplary metalens 100 is composed of a nanopost and a portion of the substrate that supports the nanopost. The nanopost within meta-unit 114 can be specified by a number of geometric parameters such as the diameter D (or the radius) of the nanopost and the height H of the nanopost. In addition, meta-unit 114 can also be specified by a period P that is also the period of the meta-unit array. Note that by changing the diameter D and/or the height H of the nanopost within meta-unit 114, the phase retardance effect of the nanopost on an incident plane wave can be modified. Note also that the diameter D of the nanoposts in different meta-units at different locations across metalens 100 can be different from one another.

Each meta-unit in metalens 100 operates by changing the phase of an incident plane wave on one side of the meta-unit after the plane wave emerges from the other side of the meta-unit. By changing the geometric parameters of the meta-units such as the diameters and the heights of the nanoposts, and positions of the nanoposts within the respective meta-units (i.e., relative to the portion of the substrate), metalens 100 can be configured into different phase profiles for different imaging applications.

FIG. 1C is a top view of the exemplary metalens 100 in FIG. 1A in accordance with the disclosed embodiments. As can be seen in FIG. 1C, metalens 100 is composed of a 2D array of meta-units that have the same grid period in both X and Y dimensions. However, the nanoposts (i.e., the dark grey dots) in the 2D array have varying diameters D across metalens 100, which indicates that metalens 100 has varying spatial phase profiles at different X-Y locations on the surface of metalens 100.

For example, when the phase profiles of the meta-units within metalens 100 are properly designed based on their distances to the center of metalens 100, metalens 100 can have an overall spatial phase profile that mimics the spatial phase profile of a bulk optical lens. However, the thickness of metalens 100 (i.e., height H of the nanopost plus the substrate thickness) is significantly smaller than the thickness of a bulk lens. Hence, compared with a conventional optical lenses, the metalens provides a significantly increased compactness and the design of the metalens has a much higher degree of flexibility. With careful design, a single metalens can obtain advanced optical functionalities that would normally require a compound structure using a bulk lens design, such as for chromatic aberration correction. Because of the compact nature of metalenses, especially in terms of the thickness, metalenses are becoming the preferred choice for highly-compact imaging systems, such as endoscopes for medical and biological investigations.

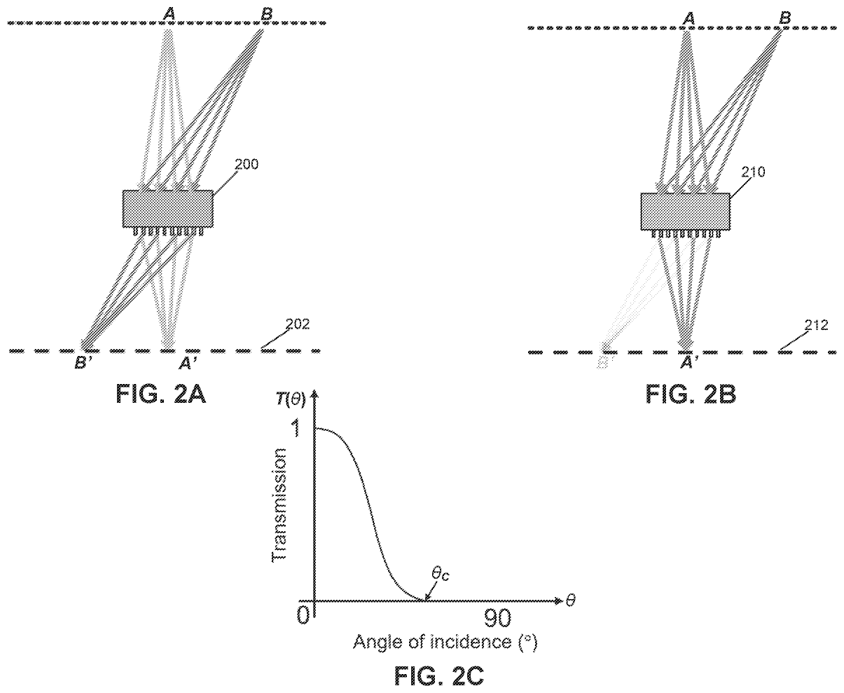

We now describe the concept of designing a metasurface with angular-dependent transmission coefficient, e.g., in terms of intensity, and using such a metasurface to implement metalenses with bounded angular FOV. FIG. 2A shows a conventional metalens design 200 that does not have a bounded angular FOV. As can be seen in FIG. 2A, both an object point source A within a small angular position with respect to metalens 200 and another object point source B from a wide angular position with respect to metalens 200 can be well-imaged onto the sensor plane 202, including strong images A′ and B′. FIG. 2B shows a proposed metalens design 210 having a bounding angular FOV in accordance with the disclosed embodiments. As can be seen in FIG. 2B, object point source A, which is within a designed FOV of metalens 210, is successfully imaged onto the sensor plane 212. In contrast, object point source B, which is outside of the designed FOV of metalens 210 is strongly rejected by metalens 210, which results in a very weak image B′ on sensor plane 212.

In various embodiments, designing a metasurface with angular-dependent transmission coefficient begins with the design of the meta-units. Generally speaking, the meta-units that are commonly used for metalens designs can be classified into two types based on how they effectuate phase retardance on an incidence light. Both types of meta-units can have a bounded angular FOV when properly designed. The first type of meta-unit operates in the manner of a short waveguide, and is typically constructed in the form of a nanopost on a dielectric substrate. As described above in conjunction with FIGS. 1A-1C, the phase retardance introduced by the first type of meta-unit depends on the specific geometric parameters of the nanoposts and the meta-units, including but not limited to, the radius/diameter and the height of the nanoposts, and the periods between meta-units. To simplify the design of a metalens using such meta-units, the period P of the meta-unit array in both dimensions and the height of the nanoposts within each meta-unit can be fixed. As such, the phase retardance profile of the constructed metalens primarily depends on the radius/diameter of the nanopost within each meta-unit.

The second type of meta-unit typically has a fixed geometry, which is usually configured as a nanofin or nanowell. Hence, the phase retardance introduced by the second type of meta-unit is generally proportional to the rotation angle of the nanofins. Note that both the first and second types of meta-units can have a bounded angular FOV when properly designed. In the discussion below, the first type of meta-unit based on the nanoposts is used as an example to describe the design procedure of a metalens having a bounded angular FOV. However, the below-described design concepts can also be applied to the second type of meta-unit to design a metalens based on nanofins or nanowells having a bounded angular FOV without departing from the present techniques. Moreover, while the meta-unit and metalens design concepts are described below based on meta-units and metalenses in transmission configurations, these design concepts can also be applied to the designs of meta-units and metalenses in reflection configurations without departing from the scope of the present techniques.

In some embodiments, the metalens design procedure starts with building a design database of meta-units. Specifically, we build a 2D array structure composed of equal-sized meta-units, wherein each meta-unit in the 2D array structure contains an identical nanopost. Next, the transmission coefficients (e.g., in terms of the transmission intensity) and phase changes caused by the meta-unit in terms of phase retardance for different incident plane waves at different incident angles are computed while varying/sweeping the period of the 2D array structure and geometric parameters (e.g., radius and height) of the nanopost in the 2D array structure. In this manner, we can obtain a database of transmission-phase and transmission-coefficient profiles for different geometric parameter configurations of the nanoposts and meta-units over a full range of light incident angles.

From this acquired phase and transmission-coefficient profile database, we then select a subset of the geometric configurations of the nanopost and the meta-units that can effectuate the intended bounded angular FOV. In other words, each selected nanopost configuration in the corresponding 2D meta-unit array structure has a similar angular-dependent transmission profile T(θ) of a decreasing transmission coefficient for an increasing angle of incidence θ and a similar cutoff angle of T(θ). Moreover, the selected subset of nanopost designs should effectuate phase changes/shifts that cover the full 2πrange. In some embodiments, the selected subset of nanopost configurations that satisfies both the angular-dependent transmission profile requirement and phase change requirements corresponds to a range of nanopost radii/diameters while keeping the nanopost height and the dimensions of the substrate structure constant.

After identifying the subset of nanopost configurations from the 2D meta-unit array simulations, a metasurface that has a specific spatial phase profile (e.g., of a bulk lens) for a specific application (e.g., imaging) can then be constructed. As has been described above, the nanoposts in different meta-units across the metasurface can have different sizes depending on the applications. For example, to construct a metasurface as a metalens, the spatial phase profile of the metasurface should possess the phase transformation behavior of a regular lens. More specifically, the spatial phase profile of the metasurface can be designed based on the ideal lens phase profile described by the following phase change versus radius relationship:

$$φ ( r ) = - \frac{κ {r}^{2}}{2 f} , \qquad ( 1 )$$

where κ is the wavevector, f is the designed focal length, and r is the radius. Note that the spatial phase profile of an ideal lens can be converted into a spatial distribution of nanopost geometric parameters, such as the nanopost diameters. Hence, by arranging meta-units within a metasurface using a subset of the selected nanopost configurations having proper phase retardance profiles, a metalens that has the spatial phase profile of an ideal lens can be obtained. An example of a metalens with arranged spatial distribution of the nanoposts of varying radius is illustrated in FIG. 1C.

Because the metalens is constructed with nanoposts from the selected subset of nanopost configurations having the same or substantially the same angular-dependent transmission profile T(θ) with a specific cutoff angle, the constructed metalens will also have the angular-dependent transmission profile to effectuate the bounded angular FOV with the specific cutoff angle. Hence, when the constructed metalens is subsequently illuminated with plane waves, the metalens only allows those plane waves with incident angles smaller than the specific cutoff angle to pass through. This means that when this metalens is used to image object point sources in an object plane, the metalens will have a bounded linear FOV in the object plane. Moreover, a given meta-unit at a distance r to the center of the constructed metalens will effectuate a phase change for the incident light at the designed wavelength that satisfies Eqn. (1). As a result, a metalens having both the spatial phase profile of an ideal lens and a bounded angular FOV is obtained. FIG. 2C shows an exemplary transmission-coefficient profile T(θ) with a cutoff angle θ_{C} in accordance with the disclosed embodiments. By designing angular-dependent transmission-coefficient profile T(θ) with a design-specific cutoff angle θ_{C}, we can control the bounded angular FOV of a meta-unit or a metalens designed based on that specific angular-dependent transmission-coefficient profile T(θ). Hence, the disclosed meta-units and metalenses have bounded angular FOVs that are fully controllable by design.

An exemplary metalens designed using the above-described design procedure for wavelength λ at 1.31 μm can have the following configurations. Assuming that in each meta-unit the nanopost is made of polysilicon and the substrate is made is fused silica, the refractive index of polysilicon at the given wavelength is 3.45 and 1.46 for the fused silica. The meta-unit array period is 0.85 μm. The nanopost height is 0.84 μm. The nanopost radius in the exemplary metalens is in the range of 140 nm to 340 nm. For the constructed metalens with radius of 0.5 mm, the number of meta-units is ˜1.4×10⁶.

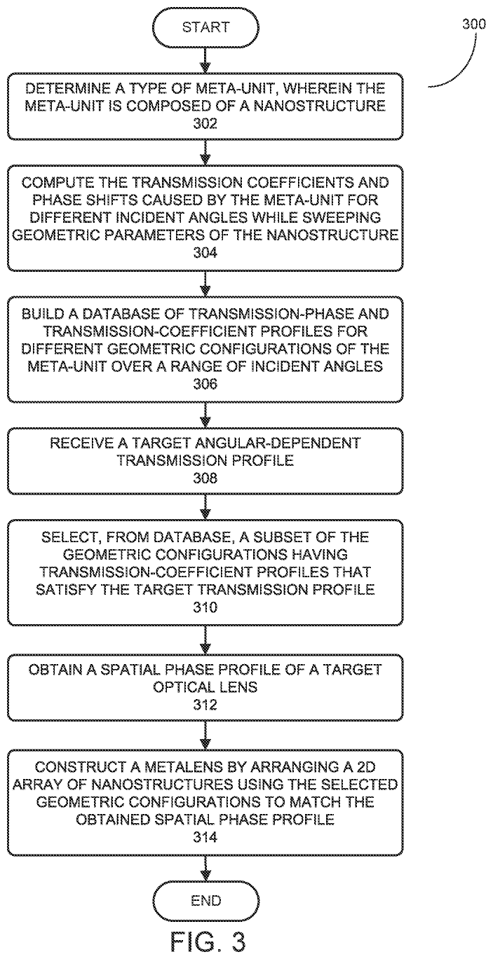

FIG. 3 presents a flowchart illustrating a process 300 of designing a metalens that has a bounded angular FOV in accordance with the disclosed embodiments. Process 300 may begin by determining a type of meta-unit, wherein the meta-unit is composed of a nanostructure disposed on a substrate support (step 302). In various embodiments, the nanostructure in the meta-unit is a nanopost that has a circular cross-section. Next, process 300 computes the transmission coefficients and phase shifts caused by the meta-unit for incident plane waves at different incident angles while sweeping a number of geometric parameters of the meta-unit (step 304). For example, when the meta-unit is made of a nanopost, sweeping geometric parameters of the meta-unit includes independently sweeping the radius and height of the nanopost. Moreover, sweeping geometric parameters of the meta-unit can include independently sweeping the size of the substrate support in the meta-structure, wherein the size of the substrate support determines a period of a 2D array of the meta-units. Next, process 300 builds a database of transmission-phase and transmission-coefficient profiles for different geometric configurations of the meta-unit over a full range of light incident angles (step 306).

Next, process 300 receives a target angular-dependent transmission profile T(θ) (step 308). Specifically, the target angular-dependent transmission profile T(θ) is a transmission-coefficient curve that decreases with an increasing angle of incidence θ and drops to zero at a predetermined cutoff angle. Process 300 subsequently selects, from the transmission-profile database, a subset of the geometric configurations of the meta-unit having transmission-coefficient profiles that satisfy the target angular-dependent transmission profile (step 310). Moreover, the selected subset of geometric configurations of the meta-unit also has the transmission-phase profiles that cover the full 2πrange. For a nanopost-type meta-unit, the selected subset of geometric configurations that satisfies the angular-dependent transmission profile can correspond to a range of nanopost diameters with a nanopost height and constant dimensions of the substrate structure.

Next, process 300 obtains a spatial phase profile of a target optical lens (step 312). For example, a spatial phase profile for an ideal convex lens vs. lens radius can be described by Eqn. (1). However, the target optical lens can include any type of optical lens, such as a convex lens, a concave lens, or a deflector. Process 300 then constructs a metalens by arranging a 2D array of nanostructures using the selected subset of geometric configurations of the meta-unit to match the transmission-phase at each location of the 2D array to the obtained spatial phase profile (step 314). Note that because the selected subset of geometric configurations of the meta-unit all have the same target angular-dependent transmission profile, the constructed metalens also has the target angular-dependent transmission profile and the bounded angular FOV.

In the disclosed metalens designs, the nanostructures that are disposed on one side of the substrate support can be either on the object side of the metalens (i.e., the side the illustration light is impinging upon) or on the image side of the metalens (i.e., the side opposite to the surface which the illustration light impinging upon). Which side of the metalens should be used to face the object plane would typically depend on the actual application.

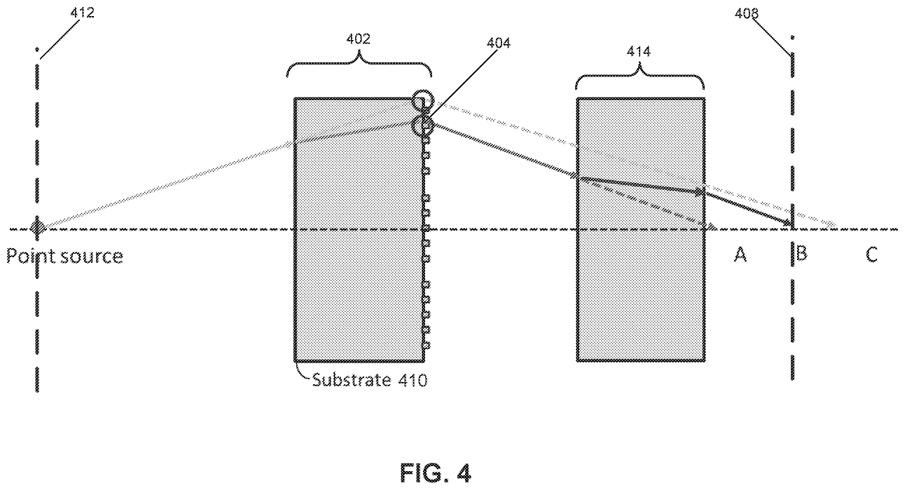

FIG. 4 illustrates an exemplary use case of a disclosed metalens 402 for high resolution 2D imaging in accordance with the disclosed embodiments. In the exemplary imaging setup shown, the nanostructures 404 of metalens 402 face and are in proximity to an image sensor in a sensor plane 408 and the substrate 410 of metalens 402 faces an object plane 412. Note that the sensor in the exemplary imaging setup of FIG. 4 is protected by a cover glass 414. In this imaging setup, it is preferable to have the nanostructures 404 face the sensor plane 408 because the substrate 410 of metalens 402 and the sensor cover glass 414 can cancel the aberration effects from both of these two optical components.

Specifically, without the substrate 410 and cover glass 414, a point source P in object plane 412 will be imaged to a location C beyond sensor plane 408, which is not desirable. When we add in substrate 410, which faces object plane 412 as shown but still without cover glass 414, point source P will get imaged to location A which is before the sensor plane 408, which is also not desirable. However, when both substrate 410 and cover glass 414 are included in the imaging system as shown, point source P will be imaged to position B on sensor plane 408, which is the intended location. Hence, by judicially choosing one side of metalens 402 to face toward the object or the sensor, the imaging system setup can cancel the aberration effects from substrate 410 and sensor cover glass 414. Note that in other applications and use cases involving metalens 402, the substrate/nanostructure facing arrangements can be different from the above scenario.

Metalens Array with Bounded Anguar FOV for Compact Imaging Systems

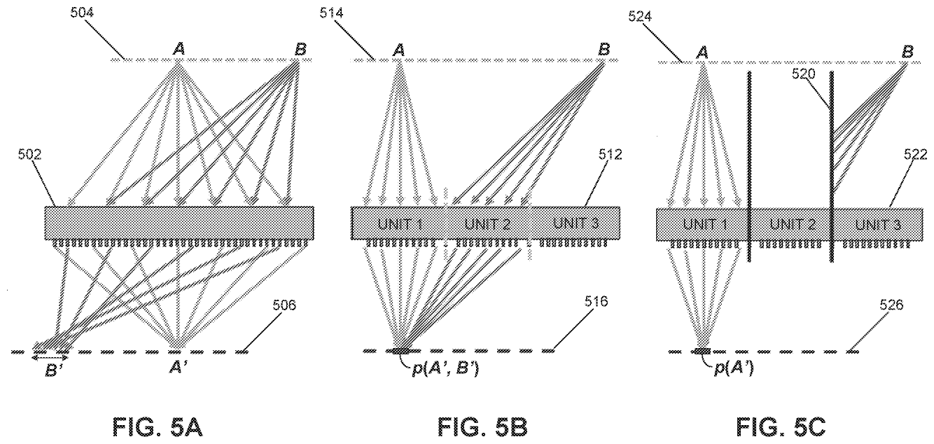

Note that the above-described metalens designs with bounded angular FOV generally have a small footprint of a few mm², and as a result, a limited FOV. Note also that while the metalens has comparable-to-wavelength thickness, there is no existing metalens imaging system that provides both compactness and a large FOV. This is mainly because existing high numerical aperture (N.A.) metalens designs also are associated with high geometric aberrations in the image planes and the non-paraxial imaging conditions (described below in conjunction with FIG. 5A). Hence, this disclosure also provides embodiments of a metalens array based on the disclosed metalens to achieve a large overall FOV for large FOV 2D imaging while keeping the device compact.

To design a compact imaging system, the focal length of the metalens should be sufficiently small. On the other hand, to increase the FOV of the metalens, the total surface area/footprint of the metalens should be sufficiently large. These two requirements would lead to certain high N.A. metalens designs that would violate the paraxial condition, thereby rendering a low-quality image due to strong aberration. For example, FIG. 5A shows the imaging quality degradation associated with a conventional metalens 502 having a large N.A. when the paraxial condition is no longer valid. As can be seen in FIG. 5A, the large footprint/surface area of metalens 502 causes a high incident-angle point β in the object plane 504 to become blurred in the sensor plane 506 as a result of geometric aberration of high N.A. metalens 502.

One technique to overcome the constraint of the paraxial condition on the N.A. of the metalens design is to use a lens array instead of a single large-footprint lens, wherein each lens unit in the lens array will have a small N.A. and operate under the paraxial condition. FIG. 5B shows the side-view of a conventional metalens array 512 that is composed of multiple small N.A. metalenses in each dimension (but only one dimension is shown). As can be seen in FIG. 5B, a single pixel, e.g., pixel p on the sensor plane 516 not only collects small FOV transmitted light from its nearest metalens unit, e.g., metalens unit 1, but also large FOV transmitted light from neighboring metalens units in metalens array 512, e.g., metalens unit 2. As a result, two object points A and B in the object plan 514 can both be imaged onto pixel p on the sensor plane 516 as shown. This inherent crosstalk between neighboring lens units at a given pixel in the sensor plane causes signal ambiguity and makes it difficult to reconstruct an object in the object plane based on the image in the image plane.

To mitigate the crosstalk problem associated with the conventional metalens array designs, extra components, such as a physical barrier or a main lens with matched numerical aperture with the lens units in the metalens array, can be combined with the conventional metalens arrays to control the lens crosstalk. For example, FIG. 5C shows a metalens array 522 wherein the metalens units are divided by physical barriers to control light sources with large incident angles. As can be seen in FIG. 5C, emitted light from object point B in object plane 524 can be blocked by a barrier 520 and therefore can no longer reach pixel p in sensor plane 526 where the image of object point A is present. However, either using additional physical barriers or a separate main lens as shown in FIG. 5C significantly increases the metalens fabrication complexity, cost, and the overall system footprint.

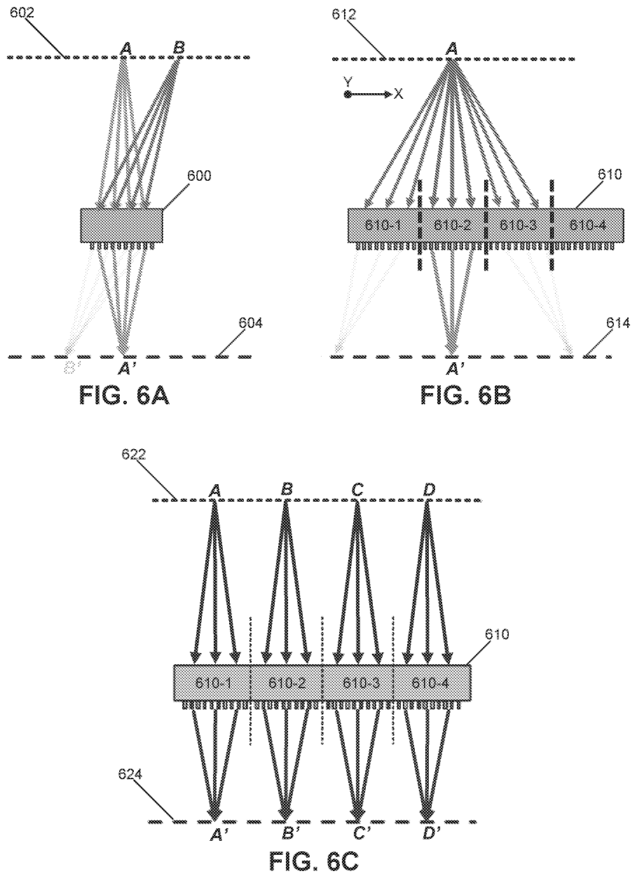

FIG. 6A shows a single metalens 600 having a bounded angular FOV and as such a bounded linear FOV in an object plane 602 in accordance with the disclosed embodiments. As can be seen in FIG. 6A, metalens 600 is configured such that it allows lights with incident angles within a predetermined/designed angular range to pass through while severely attenuating/blocking lights with incident angles outside the predetermined angular range. Note that this predetermined/designed angular range of metalens 600 is also referred to as the bounded angular FOV of metalens 600. For example, light rays emitted from object point A in object plane 602, which is within the bounded FOV of metalens 600, have incident angles that are within the predetermined angular range (i.e., the bounded angular FOV), and hence can pass through metalens 600 and produce a well-defined, strong image A′ on a sensor plane 604. In contrast, light rays emitted from object point B in object plane 602, which is outside of the bounded FOV of metalens 600, mostly have incident angles that are beyond the predetermined angular range (i.e., the bounded angular FOV), and hence are mostly rejected by metalens 600. In other words, the intensities of the light from object point B are greatly attenuated after metalens 600, and at most produce a very weak image B′ on sensor plane 604.

To extend the angular FOV and the linear FOV of metalens 600 and at the same time significantly reduce or eliminate the above-described crosstalk on the image plane, a metalens array using metalens 600 as the base unit and replicated/tiled together in both dimensions of the lens plane can be constructed. In other words, the constructed metalens array will be composed of a 2D array of metalens 600, wherein each of the metalens unit has the same bounded FOV.

FIG. 6B shows a side-view of a disclosed metalens array 610 based on metalens 600 to achieve a large FOV while mitigating crosstalk between neighboring metalens units, in accordance with the disclosed embodiments. As can be seen in FIG. 6B, metalens array 610 in the first dimension shown is composed of 4 copies of metalens 600 tiled together in the X-dimension shown. However, it should be clear to a person skilled in the art that metalens array 610 further includes 4 copies of metalens 600 tiled to one another in the Y-dimension but which are not visible in FIG. 6B. Moreover, other embodiments of metalens array 610 can have greater or fewer than 4 copies of metalens 600 in each of the two dimensions. For example, another embodiment of metalens array 610 can have 3 copies of metalens 600 in each of the two dimensions and a total of 9 copies of metalens 600 in the metalens array. Note that while metalens array 610 is constructed with an equal number of single unit 600 in both dimensions, other embodiments of the disclosed metalens array can have different numbers of single metalens unit 600 in the two dimensions. In other words, the disclosed metalens array can generally be an M×N array of single metalens unit 600, wherein M=N in some embodiments, and M≠N in some other embodiments.

FIG. 6B shows that light from object point A in object plane 612 reaches different metalens units in metalens array 610 at different angles of incidence. Specifically, for light emitted from object point A and incident on metalens unit 610-2, the incident angles are inside the bounded angular FOV of metalens unit 610-2, and hence can pass through metalens unit 610-2 and produce a well-defined, strong image A′ on a sensor plane 614. In contrast, for light emitted from object point A and incident on metalens units 610-1 and 610-3, the incident angles are beyond the bounded angular FOV/cutoff angle of these metalens units, which are copies of metalens 600 with bounded angular FOV, and hence are mostly rejected by metalens units 610-1 and 610-3.

In other words, the intensity of the light from object point A is greatly attenuated by metalens units 610-1 and 610-3 to reduce or eliminate the crosstalk contribution from point A in those regions of the sensor plane. FIG. 6C shows the use of the disclosed metalens array 610 to achieve both bounded local FOV for image crosstalk reduction and a large overall FOV in an object plane in accordance with the disclosed embodiments. As shown in FIG. 6C, the disclosed metalens array 610 can achieve bounded local FOV in each region/sub-area of the object plane 622 using a corresponding metalens unit (e.g., the unit having the smallest angular displacement) in metalens array 610. Moreover, metalens array 610 can simultaneously image all four object points A-D in object plane 622 onto image plane 624 to achieve a wide linear FOV in object plane 622.

Note that to achieve the large-incident-angle light rejections in conventional metalens arrays such as the example shown in FIG. 5C, physical barriers or a main lens would be required, e.g., by placing physical barriers 520. The disclosed metalens array 610 removes the need for such extra components for high-incident-angle light rejections and crosstalk control. Note that the disclosed metalens array 610 can be easily scaled up in both X and Y dimensions to achieve an even larger overall FOV by tiling more metalens units 600 together. A person skilled in the art would appreciate that without using a main lens or physical barriers, the disclosed metalens array 610 can be directly attached to the sample surface on one side of metalens array 610 and to the detector on the other side of metalens array 610, thereby obtaining a highly compact imaging device with a large FOV for microscopic imaging applications.

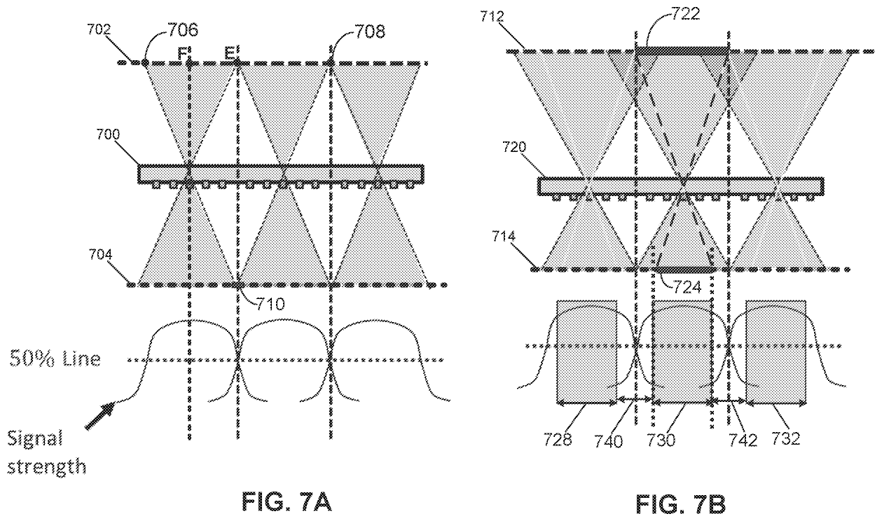

As discussed above, the disclosed metalens designs have a high degree of design flexibility. This flexibility allows the phase profile of each metalens unit to be customized and/or optimized to achieve better imaging performance instead of simply using the ideal lens phase profile. In some embodiments, when designing the metalens unit for use in the disclosed metalens array, the imaging specifications, such as the imaging magnification and lens N.A. of the metalens unit should be first determined. Specifically, the N.A. of the metalens unit is matched with the bounded angular FOV. FIG. 7A shows an exemplary technique of calibrating metalens units within a disclosed metalens array 700 by matching the lens N.A. with the bounded angular FOV in accordance with the disclosed embodiments.

As can be seen in FIG. 7A, the imaging magnification of each metalens unit of metalens array 700 is set to 1 so that an object in an object plane 702 is imaged to the sensor plane 704 with a 1:1 size ratio. Next, we compute the point spread function (PSF) for a first point source (e.g., point source E) in object plane 702 that has its projection in the lens plane on the boundary between two adjacent metalens units in metalens array 700. We also compute the PSF for a second point source in object plane 702 that is on the optical axis of a given metalens unit (e.g., point source F). The N.A. of the metalens unit is then adjusted until the strength of the PSF for the first point source is substantially half of the strength of the PSF for the second point source, as shown in FIG. 7A. Note that in the design of the metalens unit shown in FIG. 7A, the unity imaging magnification condition can achieve both a maximal imaging resolution in the sensor plane 704 and at the same time a degree of image separations of different objects in object plane 702 projected onto sensor plane 704 by different metalens units in metalens array 700. However, as can be observed in FIG. 7A, a small amount of signal overlap/ambiguity still exists for object points in the in-between unit regions, such as object points 706 and 708, which can be imaged onto the same image pixel 710 in sensor plane 704.

FIG. 7B shows an alternative design of the metalens units within a disclosed metalens array 720 by matching the lens N.A. with the bounded angular FOV, in accordance with the disclosed embodiments. In the exemplary design process of FIG. 7B, the imaging magnification is chosen to be less than 1 (e.g., 0.7) while the signal strength profiles in FIG. 7A are maintained. As a result, an entire object (e.g., object 722) in object plane 712 having the same size as each metalens unit can be imaged onto sensor plane 714 as image 724 and the entire image is inside an effective window 730 that does not overlap with neighboring effective windows 728 and 732 associated with the neighboring metalens units in the metalens array 720. Note that this design technique can achieve a reasonably high imaging resolution in the sensor plane 714, and at the same time avoid the signal overlap/ambiguity for object points in the boundary regions. Note that the regions in sensor plane 714 in between the effective windows, e.g., regions 740 and 742, will have object signal overlapping and therefore can be computationally discarded. In a specific design example, the disclosed metalens array has 3×3 metalens units and each metalens unit has a size of 1 mm×1 mm. Moreover, each lens unit has a focal length of 0.95 mm. The nominal lens to object plane distance is 2.3 mm and the distance between the sensor plane and the metalens array is 1.61 mm. The operating wavelength is 1.31 μm.

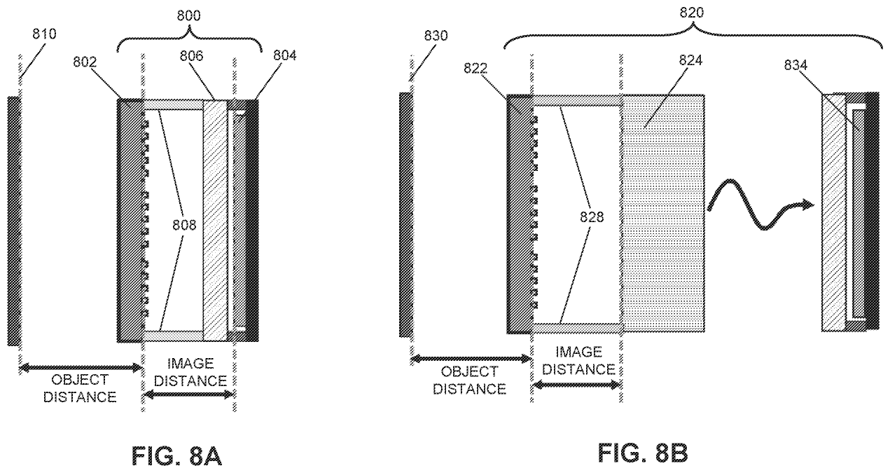

FIGS. 8A and 8B show two different setups wherein the disclosed metalens array can be integrated into an imaging system for large FOV microscopic imaging. Specifically, FIG. 8A shows a compact camera system 800 constructed by directly integrating a disclosed metalens array with an image sensor in accordance with the disclosed embodiments. As can be seen in FIG. 8A, a metalens array 802 is mechanically coupled to an image sensor 804 protected by a cover glass 806 through spacers 808 to form the compact camera system 800. Note that the nanostructures in metalens array 802 are facing image sensor 804 to mitigate the aberration effects as described in conjunction with FIG. 4. In some embodiments, a cable can be used to power up the camera system 800 and to transmit the captured images. Alternatively, the power supply and data transmission can be implemented in the compact camera system 800 through wireless communication means. Because of the compactness of camera system 800, camera system 800 can be attached to a subject at a sample surface 810, e.g., to a mouse skull for brain imaging for neuroscience application, or to a human body to monitor the tissue either on the surface skin or inside the body through endoscopy.

FIG. 8B shows a flexible camera system 820 constructed by coupling a disclosed metalens array to an image sensor through a fiber bundle in accordance with the disclosed embodiments. As can be seen in FIG. 8B, a metalens array 822 is attached to one end surface of a fiber bundle 824 through spacers 828, wherein the other end surface of fiber bundle 824 is coupled to an image sensor 834. Hence, fiber bundle 824 is used to deliver images formed by metalens array 822 to image sensor 834. Note that in the flexible camera system 820, the part of the device that is attached to the subject at sample surface 830 can be lighter than compact camera system 800. Depending on the specific applications, either the imaging setup of FIG. 8A or the imaging setup of FIG. 8B can be used.

### Metasurface Angular Filter

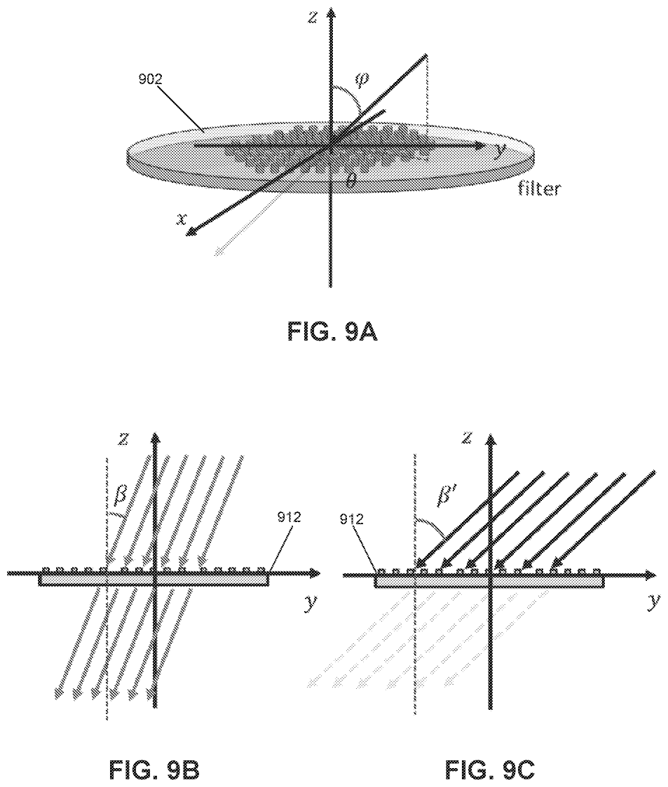

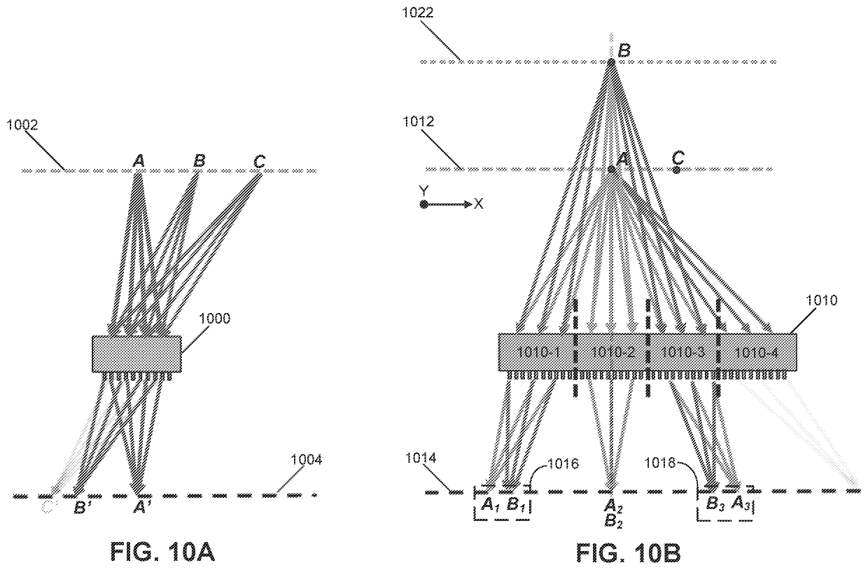

The above-described meta-unit and metasurface with angular-dependent transmission coefficient can also be used to construct angular filters. An angular filter is a type of optical device that has a limited acceptance angle for the incident light. Angular filters have found a wide range of applications in optical system designs, such as in optical communications, optical coupling, and imaging applications. Conventionally, an optical filter is typically designed to filter out the undesirable wavelengths of light while keeping the desirable wavelengths of light. An angular optical filter, in addition to possessing the basic property of an optical filter, can also selectively pass incoming light based on a designed angular range. Specifically, if the incoming light has an incident angle greater than a threshold value, i.e., the cutoff angle of the bounded FOV by design, the transmission intensity of the angular optical filter will drop rapidly. For example, FIG. 9A shows a 3D representation and filtering operation of a metasurface angular filter 902 in accordance with the disclosed embodiments. In FIG. 9A, φ is the incident angle, i.e., the angle between the light propagation direction and Z-axis, whereas θ is the angle between the projection of light in x-y plane and the x-axis. When metasurface angular filter 902 is properly designed, the light transmission through filter 902 will become close to zero when angle φ is greater than the threshold value/cutoff angle. Note that conventional absorption-based optical filters do not have such angular-dependent light filtering feature.

A grating-like metasurface angular filter has been reported by Q. Y. Qian et al., “All-dielectric ultra-thin metasurface angular filter,” Opt Lett 44, 3984-3987, 2019. However, this type of metasurface angular filter only works in one dimension. Using FIG. 9A as an example, if the existing metasurface angular filter has worked for an incident light with θ equal to 0, the grating-like metasurface angular filter will not work when θ equal to 90°. Moreover, the existing device will only work partially for incident light with θ angle other than 0° and 90°, because such incident light can always be decomposed into one light component with θ angle equal to 0 and another light component with θ angle equal to 90°.

The disclosed metasurface angular filter with angular-dependent FOV can overcome the deficiencies in the existing metasurface angular filter because it provides a symmetric angular filtering effect. FIG. 9B shows a 2D side-view and a first type of filtering operation of a disclosed metasurface angular filter 912 in accordance with the disclosed embodiments. As can be seen in FIG. 9B, the incident angle β of the incoming light is less than the designed cutoff angle of metasurface angular filter 912. As such, the transmitted light of the incoming light can have a high intensity.

In contrast, FIG. 9C shows the same 2D side-view but the second type of filtering operation of the disclosed metasurface angular filter 912 in accordance with the disclosed embodiments. As can be seen in FIG. 9C, the angle β of the incoming light is greater than the designed cutoff angle of metasurface angular filter 912 which results in the incident light being rejected by disclosed metasurface angular filter 912, i.e., having a very small or zero transmission as shown. As can be observed from both FIGS. 9B and 9C, unlike the disclosed metalens that is required to provide specific spatial phase retardance, the disclosed metasurface angular filter does not need to have a phase profile to change the wave propagating direction. Consequently, all the meta-units that form the disclosed metasurface angular filter can be identical. This means that to design such an angular filter, we can simply choose a nanopost geometric configuration (e.g., choosing a particular nanopost radius) that provides the desired bounded angular FOV.

Metalens Array with Bounded Anguar Field-of-View for 3D Imaging

In addition to 2D imaging, the metalens array can also perform snap shot (or single shot) three-dimensional (3D) imaging by projecting 3D scenes/objects into a single 2D image in an image/sensor plane. The 3D scenes/objects can then be computationally reconstructed from the obtained 2D image. Generally speaking, for 3D imaging, we design a metalens array with metalens units that have a greater cutoff angle, i.e., a greater angular FOV than metalens units used in a metalens array for 2D imaging. This means that a metalens unit used in a metalens array for 3D imaging will generally have a wider angular-dependent transmission profile T(θ) and a larger cutoff angle than the transmission profile T(θ) and the corresponding cutoff angle of a metalens unit used in a metalens array for 2D imaging. This wider T(θ) with the greater cutoff angle allows a single object in the object plane to be imaged into multiple copies in the image plane. However, illuminations from the object that are above the cutoff angle will be rejected by the metalens array.

FIG. 10A shows the concept of designing a metalens unit 1000 having a proper angular FOV and cutoff angle for use in a metalens array for 3D imaging in accordance with the disclosed embodiments. As can be seen in FIG. 10A, metalens 1000 is configured such that it allows light rays with incident angles within a predetermined bounded angular FOV to pass through while severely attenuating/blocking lights with incident angles outside the predetermined bounded angular FOV. For example, light from object points A and B in the object plane 1002 and impinging upon metalens 1000 is within the bounded angular FOV of metalens 1000. As a result, object points A and B are clearly imaged onto a sensor plane 1004 to produce strong images A′ and B′. In comparison, the metalens unit 600 in FIG. 6A used in a metalens array for 2D imaging has a smaller bounded angular FOV and corresponding cutoff angle, which resulted in the rejection of object point B in image plane 604. However, light from object point C in object plane 1002 of metalens 1000, which is outside of the bounded angular FOV of metalens 1000, is greatly attenuated after metalens 1000, and at most produces a very weak image C′ on sensor plane 1004.

FIG. 10B shows a side-view of a disclosed metalens array 1010 constructed based on metalens 1000 in FIG. 10A for 3D imaging, in accordance with the disclosed embodiments. As can be seen in FIG. 10B, metalens array 1010 is composed of 4 copies of metalens 1000 tiled together in the X-dimension shown. However, it should be clear to a person skilled in the art that metalens array 1010 also includes 4 copies of metalens 1000 tiled to one another in the Y-dimension. Moreover, other embodiments of metalens array 1010 can have greater or fewer than 4 copies of metalens 1000 in each of the two dimensions. For example, another embodiment of metalens array 1010 can have 3 copies of metalens 1000 in each of the two dimensions and a total of 9 copies of metalens 1000 in the metalens array. In some embodiments, a disclosed metalens array for 3D imaging can tile different numbers of single metalens unit 1000 in the two dimensions, e.g., 4 copies of metalens 1000 in the X-dimension and 3 copies of metalens 1000 in the Y-dimension.

FIG. 10B also shows that light from object point A in the first object plane 1012 and on the optical-axis of the second metalens unit 1010-2, reaches different metalens units in metalens array 1010 at different angles of incidence. In some embodiments, the cutoff angle of metalens 1000 is designed such that the incident angles from object point A are inside the bounded angular FOVs of three metalens units: 1010-1, 1010-2, and 1010-3. As a result, three copies of images of object point A are produced in the image plane 1014: image A₂ in the middle as the center image; and image A₁ and image A₃ on either side of the center image A₂. However, for the light from object point A and incident on metalens unit 1010-4, the incident angles are beyond the bounded angular FOV/cutoff angle of metalens 1000, and hence are rejected by metalens unit 1010-4.

For the exemplary 3D imaging, FIG. 10B also shows a second object point B that is positioned directly behind object point A and in the second object plane 1022 at a greater object distance from metalens array 1010 than object point A in the first object plane 1012. Similar to object point A, object point B is also projected in the image plane 1014 three times to produce three images: image B₂ in the middle as the center image and overlapping with image A₂; and image B₁ and image B₃ on either side of the center image B₂ but with a lateral offset from image A₁ and image A₃ of object point A, respectively, so that the other two images of object points A and B do not overlap.

After projecting 3D object positions through metalens array 1010 onto the 2D image plane 1014, a computational technique can be used to distinguish images of two or more objects from different object distances but are within a small area close to each other on the image plane 1014, e.g., image A₁ and image B₁ within a small area 1016, and image A₃ and image B₃ within a small area 1018, respectively. In some embodiments, metalens array 1010 can be configured to generate K×L copies of images in image plane 1014 for each object in the 3D object space, wherein K and L can be determined based on the specific computational technique used to distinguish 3D objects in the 2D image plane. In some embodiments, K=L; while in some other embodiments, K≠L.

In the embodiment shown in FIG. 10B as an example, three images for each object generated in a single dimension means that a total of 3×3 copies of images are generated in the 2D image plane. This means that metalens array 1010 may need only 3×3 metalens units. In other embodiments, two copies of images for each object in each dimension, and 2×2 copies of images in the 2D image plane may be sufficient to distinguish object A from object B. Note that the number of copies of images requires to distinguish 3D objects in the 3D image plane 1014 may be determined by the sparsity of the objects being imaged.

Depending on the spatial phase profile of each metalens, we can build different types of metalens array for 3D imaging. In the conventional design, each metalens unit can have an ideal lens phase profile:

$$φ ( r ) = - \frac{κ {r}^{2}}{2 f} , \qquad ( 1 )$$

wherein κ is the wavevector, f is the designed focal length, and r is the radius. However, this metalens design technique has a tradeoff between resolution and depth of view. For high-resolution imaging, there is generally a very limited number of resolvable axial layers. To extend the 3D imaging volume while maintaining a good imaging resolution, we can design each metalens unit so it has an extended depth of view. Similar to the 2D imaging, the metalens array can be directly attached to the sample surface and the image sensor due to the absence of main lens, thus achieving a compact large FOV 3D camera for microscopic imaging application. The specific metalens-sensor integration setups can be either one discussed above in conjunction with FIGS. 8A and 8B.
Metalens Array with Extended Depth of View (DOV) for 3D Imaging

Note that for high resolution light field imaging, there are usually a very limited number of resolvable axial layers for imaging a 3D object. To extend the 3D imaging volume while maintaining a good imaging resolution, we can design/configure each metalens unit within a metalens array to have an extended (i.e., large) depth of view (DOV) in the axial direction (i.e., Z-direction). In some embodiments, to enable an entire metalens array to have the extended DOV, each individual metalens unit within the metalens array is configured with a phase-shift profile to effectuate a Bessel beam point spread function (PSF) for each object source in an object plane within the extended DOV.

Note that the Bessel beam PSF is associated with a much longer DOV than other common optical beams such as Gaussian beam PSF, and therefore can resolve a much larger object/imaging volume (i.e., by extending in the axial direction) than typical optical designs, and at the same time maintain high lateral resolutions. In other words, for each object source within the designed extended DOV of the metalens unit, the image of the object source projected onto the image plane of the metalens unit will remain a sharp circular spot with very little diffraction. Moreover, for multiple object sources having different Z-distances along the axial direction while remaining inside the designed extended DOV, the images of these object sources projected onto the image plane of the metalens unit will all have sharp circular patterns with substantially the same size.

It is known that the Bessel beam PSF can be generated by using an axicon. Hence, we can either configure each metalens unit into an axicon shape to effectuate the Bessel beam PSF. Alternatively we can configure each metalens unit to have a phase-shift profile of an axicon, which then may be referred to as a “meta-axicon” unit. As a result, the metalens array with the extended DOV becomes a meta-axicon array. Note that the phase-shift profile of metalens unit or meta-axicon unit to effectuate the Bessel beam can be described by the following phase change (or “phase shift”) versus radius relationship:

$$φ ( r ) = a \vert r \vert , \qquad ( 2 )$$

wherein α is a design parameter of the metalens unit that is used to control the length of the approximated the Bessel beam in the axial direction, and r is the radius. Hence, we can control the extended DOV of the metalens unit/meta-axicon unit by controlling the value of parameter a, which itself is a function of a range of the focal length (i.e., fₘᵢₙ and fₘₐₓ) corresponding to the extended DOV, as well as the effective diameter D of the metalens unit.

Note that the concept of designing an optical lens with extended DOV using lens units configured with a phase-shift profile to effectuate the Bessel PSF for 3D imaging is not limited to metalens arrays. Some embodiments of the present techniques also include designing lens arrays with extended DOV for 3D or light field imaging, wherein the phase-shift profile of each lens unit within the lens array is configured to be an axicon or an axicon equivalent, so that each of the lens unit is configured to generate the Bessel beam PSF. Some embodiments of the present techniques also include designing lens arrays for 3D or light field imaging, wherein each lens unit within the lens array is configured with a phase-shift profile to effectuate both a large/extended DOV and a high image resolution, so that the lens array can be used to image a large volume with high resolution.

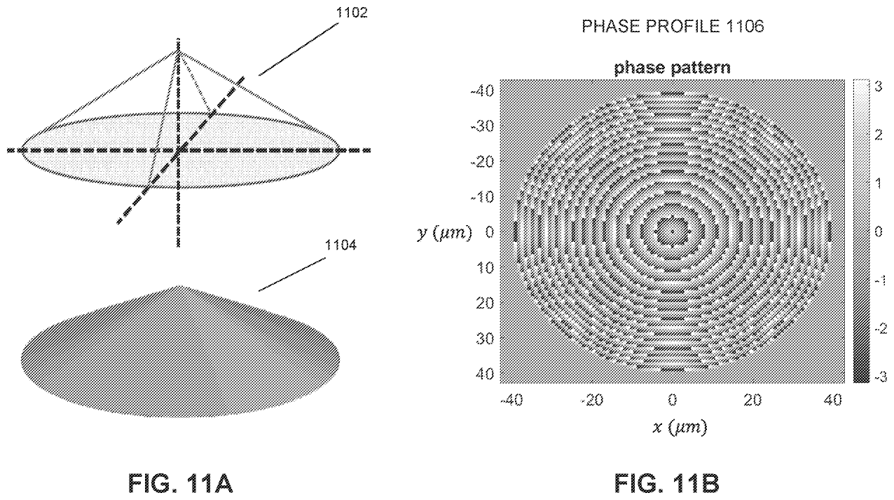

FIG. 11A shows an exemplary spatial profile of an axicon both in a schematic view 1102 and a realistic 3D view 1104 in accordance with the disclosed embodiments. FIG. 11B shows an exemplary phase profile 1106 of a meta-axicon that is designed for 3D imaging applications to effectuate the extended DOV in accordance with the disclosed embodiments.

Note that in addition to Bessel beam point spread function, other extended depth of view imaging techniques such as those that generate cubic phase point spread functions or double helix point spread functions can also be used to design individual metalens units and the metalens arrays to effectuate the extended DOV. In some embodiments, to construct a metalens array for compact imaging systems that can perform a large FOV light field imaging, individual metalens units within the metalens array are configured with a phase-shift profile to effectuate either a cubic phase point spread function or a double helix point spread function. In some other embodiments, to construct a lens array (other than a metalens array) for light field imaging, individual lens units within the lens array for light field imaging are configured with a phase-shift profile to effectuate either a cubic phase point spread function or a double helix point spread function.

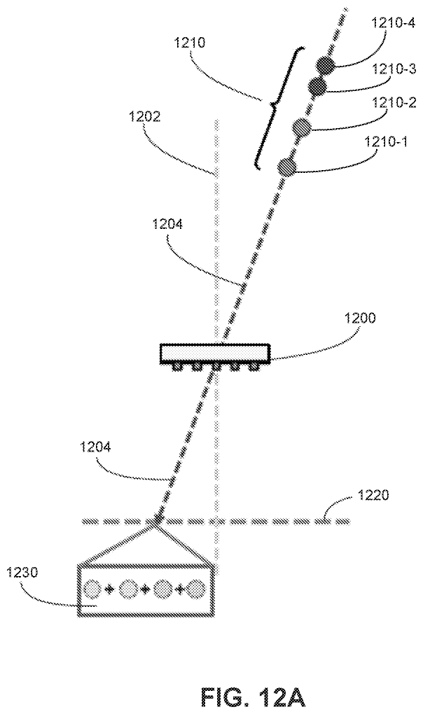

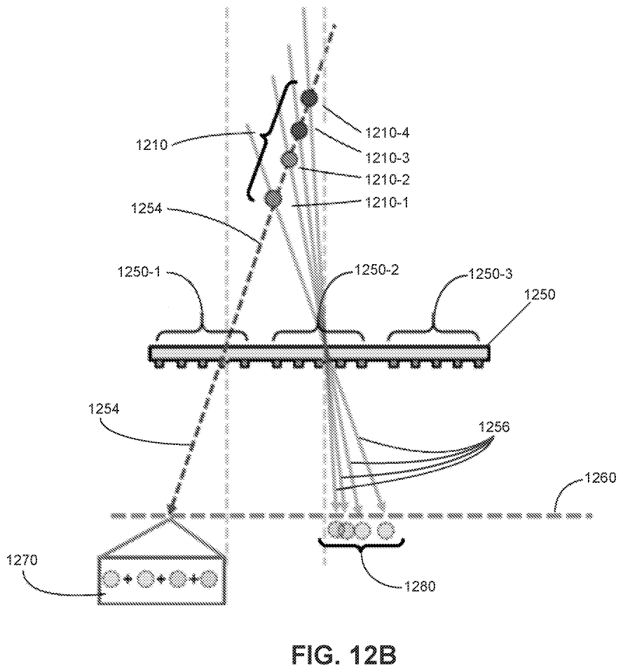

Note that in a single metalens designed with extended DOV, the point spread function of the Bessel beam can lead to undesirable behavior because the long depth of focus of the Bessel beam can cause light sources at different depths, i.e., different Z-distances along the axial direction, to superimpose with each other on the image plane, thereby causing signal ambiguities. FIG. 12A shows the use of an exemplary single metalens 1200 configured with Bessel beam PSF to image a 3D object 1210 composed of multiple object point sources in accordance with the disclosed embodiments. As can be seen in FIG. 12A, the single metalens 1200, such as a single meta-axicon unit, is configured with an array of nanostructures having an axicon phase profile to effectuate Bessel beam PSF. On the object side of metalens 1200 (i.e., above metalens 1200), an object 1210 is made up of four object point sources 1210-1 to 1210-4, which are positioned at different axial layers in the Z-axis 1202 and aligned at an angle skewed from Z-axis 1202. In this example, emitted light rays 1204 from these object point sources follow substantially the same skewed angle through the single metalens 1200 with Bessel beam PSF to the image/sensor plane 1220 of the camera system. The combined light rays 1204 after passing through single metalens 1200 are projected onto image plane 1220 as an object image 1230. However, object image 1230 is the result of the four individual object-point-source images superimposed together and indistinguishable from one another within the object image 1230.

In contrast, when a metalens array composed of a 2D array of those metalens units having the extended DOV (e.g., a meta-axicon array composed of 2D meta-axicon units) is used for 2D or 3D imaging, a single object point source can be imaged by more than one lens unit into multiple copies of object images. Using such a metalens array to image 3D objects will allow certain depth information that is indistinguishable by a single metalens unit to be resolved, such as the scenario depicted in FIG. 12A. FIG. 12B shows the concept of resolving the multiple object point sources in FIG. 12A using an exemplary metalens array 1250 having an extended/large DOV in accordance with the disclosed embodiments. As can be seen in FIG. 12B, instead of the single metalens 1200 of FIG. 12A, metalens array 1250 comprising multiple copies of the single metalens 1200 is used to image object 1210 made up of the four object point sources 1210-1 to 1210-4. Specifically, each of the multiple metalens units within metalens array 1250, such as shown 1250-1, 1250-2, or 1250-3, is configured with Bessel beam PSF. Note that the combined light rays 1254 emitted from all four object point sources of 3D object 1210 pass through the first copy of the metalens unit 1250-1 and are projected onto the image/sensor plane 1260 of the camera system to form the image 1270 of the object 1210, wherein the individual images of the object point sources are superimposed together and indistinguishable within image 1270.

FIG. 12B also shows that the second copy of the metalens unit 1250-2 configured with the extended DOV and the Bessel beam PSF is also used to image the 3D object 1210. Specifically, a group of light rays 1256 emitted from all four object point sources 1210-1 to 1210-4 following different angular paths is transmitted through metalens unit 1250-2 and projected onto the same image/sensor plane 1260 of the camera system to form a cluster of image spots 1280. Note that each of the individual image spots within the cluster 1280 remains in focus, i.e., with a sharp image of the corresponding object source, and at a different location in the image plane. Because individual image spots within the cluster 1280 have sufficient offsets from other image spots in the cluster, they are fully resolved in the second copy of the image of the 3D object 1210. Thus, the disclosed metalens array composed of metalens units having the extended DOV allows a 3D cluster of object point sources to have distinguishable separations in the image plane. Moreover, the resolution/separation of the image spots for different object point sources can be further increased by reconfiguring the disclosed metalens array/metalens unit to have an even greater DOV. As such, the disclosed metalens array can be used for large volume 3D imaging with high resolvability and high resolution.

FIG. 12B demonstrates that when a metalens array composed of multiple metalens units configured with Bessel beam PSF is used to image a cluster of 3D object point sources, each object point source can be imaged by multiple metalens units to form multiple image spots, and as a result, the cluster of 3D object point sources is also imaged to multiple clusters of image spots in the same image plane. Subsequently, the depth information (Z-positions) of the cluster of object point sources can be resolved by combining the information from the multiple clusters of image spots. Note that, however, if a regular metalens unit is used in metalens array 1250 in place of metalens unit 1250-2 with the extended DOV, then some image points in image cluster 1280 will be in focus/sharp, while some other image points will be out of focus/diffracted. This will result in the image spots overlapping, thereby making it difficult or impossible to be resolved.

In various embodiments, the disclosed metalens array of metalens units configured with the extended DOV can be used to perform large FOV light field imaging. In these embodiments, the large FOV is achieved by including more physical copies of the metalens units to cover bigger areas in an object plane so that a large 2D object at a given object plane/axial layer can be imaged all at once. For example, 10×10 metalens units of size 1 mm×1 mm may be needed to cover a 10 mm×10 mm 2D object at an object plane Z1. This allows a 1-to-1 mapping of all pixels in the object plane to the pixels in the image plane.

However, when the metalens array with the extended DOV is also used to simultaneously image a second object plane/axial layer Z2 for 3D imaging, the size of the metalens array (i.e., the number of copies of the metalens units) may not have to be increased if a compressed sensing technique is used to process the combined image of the object planes Z1+Z2 to reconstruct all object points in both object planes. Note that when the object pixels in each object plane/axial layer are sparse, even more object planes/axial layers can be imaged at once by the same metalens array without increasing the size of the metalens array. However, this also requires that the metalens array has a large DOV.

Note that for the large FOV 3D imaging applications, a metalens array composed of many copies of the metalens units, e.g., 10×10 units, can still cause confusion and uncertainty for the compressed sensing/object reconstruction models, because each object point can be imaged to too many copies (e.g., 100) of corresponding images on the image plane. Note that among these many copies of the same object, some copies at large incident angles are far away from the center of the metalens array and associated with poor PSFs of very low image quality.

Referring back to FIG. 10B as an example, note that if the 4 copies of metalens in the X-direction within metalens array 1010 were not designed with the bounded angular FOVs, then four copies of images of each of the object points A and B would have been produced in the image plane 1014. If metalens array 1010 also has 4 copies of metalens in the Y-direction, then a total of 16 copies of images of each of the object point A and B would have been produced in the image plane 1014. By the same token, metalens array 1010 would have also produced 16 copies of images of object point C within the same object plane 1012 as object point A (though light emitted from object point C and the corresponding images of object point C in image plane 1014 were not explicitly shown in FIG. 10B). This would mean that 16 clusters of image spots of object points A, B, and C would have been produced at 16 different locations/areas in image plane 1014.

On one hand, multiple copies of image clusters (e.g., 3 copies) of a cluster of object sources will increase the level of confidence of the compressed sensing/object reconstruction models to resolve different object sources within the image clusters. On the other hand, too many copies of image clusters of the cluster of object sources can cause confusion and uncertainty, because images of objects at large incident angles would overlap each other due to poor PSFs. Generally, it is found that 3 to 9 copies of images of the object sources will be sufficient for the object reconstruction models to resolve different objects in an object cluster.

In some embodiments, to limit the number of copies of images of the same object produced by the disclosed metalens array with the extended DOV for large FOV 3D imaging, each metalens unit within the disclosed metalens array is not only configured with the extended DOV, but also configured with the bounded angular FOV. Embodiments of metalens units configured to have bounded angular FOVs and used in metalens array for 3D imaging have been described in conjunction with 10A-10B (e.g., metalens unit 1000 in FIG. 10A), and metalens units 1010-1 to 1010-4 in FIG. 10B. To enable the extended DOV, these metalens units should also be configured with a phase-shift profile, e.g., an axicon phase profile to effectuate a Bessel beam PSF or other alternatives to effectuate the extended DOV, such as the cubic phase PSF or the double helix PSF. The disclosed metalens array composed of metalens units configured with both the extended DOV and the bounded angular FOV when applied to 3D imaging will significantly limit the number of copies of images of the same object produced by a large metalens array.

For example, if the bounded angular FOV similar to those used in metalens array 1010 is implemented in the metalens array having both the extended DOV and the bounded angular FOV, the metalens array will generate just 3 copies of images of an object within the corresponding extended DOV in one dimension, and 3×3 (i.e., 9) copies in total (i.e., in the 2D image plane). Alternatively, we can configure the metalens units within the metalens array with extended DOV to have an even smaller bounded angular FOV than the bounded angular FOV of metalens array 1010. This implementation will further reduce the number of copies of images of an object within the corresponding extended DOV to ˜2 copies in one dimension, and 2×2 (i.e., 4) copies in total.

Generally speaking, we can control the bounded angular FOV associated with the metalens units such that the corresponding metalens array having the extended DOV will produce between 4 and 9 total copies of images of an object within the corresponding extended DOV. We refer to this limited number of copies of images produced for an object controlled by the bounded angular FOV of metalens units within a metalens array having the extended DOV as the “effective copies.” Note that the number of effective copies associated with the disclosed metalens array is generally significantly smaller than the number of metalens units (e.g., 10×10 units) within the disclosed metalens array. Note that instead of or in addition to controlling the bounded angular FOV of each metalens unit, it is also possible to limit the number of copies of images by using smaller metalens units to limit the FOV of each metalens unit.

In some embodiments, to design each metalens unit to have both the extended DOV and the bounded angular FOV using nanostructures, the general metalens design concepts described in conjunction with FIG. 3 can be applied herein. This includes selecting a set of geometric configurations of the meta-unit including nanostructures having transmission-coefficient profiles that satisfy the target bounded angular FOV. Moreover, the selected set of geometric configurations of the meta-unit also has the transmission-phase profiles that cover the full 2πrange. Next, we can construct a metalens unit by arranging a 2D array of nanostructures using the selected set of geometric configurations of the meta-unit to match the transmission phase at each location of the 2D array to the phase-shift profile that effectuates the extended DOV, such as the phase-shift profile described by Eqn. (2) that effectuates the Bessel beam PSF.

Note that compared to the metalens designs for 2D imaging applications in FIGS. 6A-6C, which limit the effective copies of images to about one copy to minimize the crosstalks, the bounded angular FOV designed for the metalens units in the metalens array for 3D imaging applications will generally have a broader transmission-coefficient profile and a greater cutoff angle than the corresponding transmission-coefficient profile and cutoff angle associated with the metalens designs in FIGS. 6A-6C for 3D imaging applications. This allows the disclosed metalens arrays for 3D imaging to generate a greater number of effective copies of images than the metalens designs for 2D imaging.

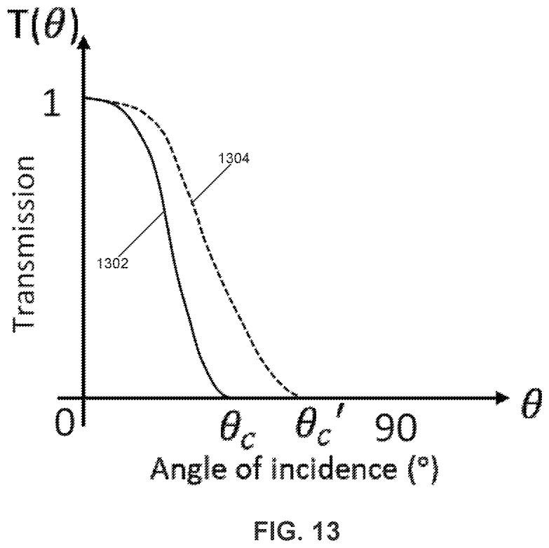

FIG. 13 shows exemplary transmission-coefficient profiles T(θ) and the corresponding cutoff angles for 2D imaging applications and 3D imaging applications on the same plot in accordance with the disclosed embodiments. Specifically, the solid line T(θ) profile 1302 is the transmission-coefficient profile for 2D imaging applications while the dashed line T(θ) profile 1304 is the transmission-coefficient profile for 3D imaging applications. As can be seen, T(θ) profile 1304 has a larger cutoff angle θ_{C} and hence a large angular FOV, thus is more appropriate for 3D imaging applications. In contrast, T(θ) profile 1302 has a smaller cutoff angle θ_{C} and hence a smaller angular FOV, thus is more appropriate for 2D imaging applications.

Note that there are multiple techniques for performing 3D object reconstruction in a 3D imaging system that uses the disclosed metalens array for performing large DOV and large FOV 3D imaging. One type of object reconstruction technique is based on light field imaging and uses a ray-tracing approach for object reconstruction. Specifically, this technique originates from a light field camera that has a main lens configured with a matched numerical aperture with the microlens unit of a microlens array. The same ray-tracing approach can be applied to the multiple copies of images of a 3D object volume to reconstruct and distinguish different object sources in the 3D object volume projected onto the image plane, such as the clusters of image spots in image plane 1014 shown in FIG. 10B and the clusters of image spots in image plane 1260 shown in FIG. 12B.

In some embodiments, the ray-tracing-based reconstruction technique uses the following scaling rule to distinguish two object point sources having different Z distances in the axial direction: (1) an object point source having a greater Z distance in the axial direction is projected onto the image plane closer to the center of the image plane; and (2) an object point source having a smaller Z distance in the axial direction is projected onto the image plane further away from the center of the image plane. Note that ray-tracing-based reconstruction techniques are generally fast and low in computational complexity.

Another type of reconstruction technique is based on iterative optimization techniques, such as the Richardson-Lucy deconvolution method, or ADMM solver. Mathematically speaking, the imaging process can be formulated as Y=AX+n in linear algebra, wherein X is the object vector that carries the information of the object, Y is the image projected onto the sensor, A is the system matrix for mapping the object to the corresponding image, and n is the noise inherent to the imaging system. Note that once the configuration of the metalens array for 3D imaging is fixed, the corresponding A matrix becomes known. The goal of a given iterative optimization technique can be defined as recovering X based on Y and the known A matrix. Except for some simple cases where the solutions to X can be resolved directly, iterative techniques are typically needed and hence applied to recover the object information X.

In some embodiments, when applying the iterative techniques, we can first estimate an initial solution X₀. Next, we can calculate the image generated from X₀ as Y₀=AX₀+n and compare it with the actual image Y. After this step, the estimated solution will be updated as X₁ with a goal that Y₁ can be closer to Y. The above iterative steps are repeated until the convergent criterion is fulfilled, i.e., when the difference between Y and Yₙ becomes sufficiently small. Note that the iterative techniques can typically only get a solution that is sufficiently close to the real answer instead of the exact solution itself.

Compared to the ray-tracing-based techniques, iterative optimization techniques have higher performances and generate higher quality solutions. However, they typically take a longer time to complete and require more computational resources. In a 3D imaging system based on the metalens array configured with both the extended DOV and the bounded angular FOV, the PSFs of the effective copies of images in the image plane are well confined. This unique feature of the disclosed the metalens array can make the iterative optimization techniques to run faster and easier to converge. As mentioned above, there are various iteration techniques, such as the Richardson-Lucy deconvolution technique, ADMM solver, among others.

A third type of reconstruction technique is based on the powerful deep-learning method. The deep-learning-based reconstruction technique uses trained models that generally have very fast reconstruction speeds and wide applications. The technique typically requires a large amount of training data and long training time. However, once the reconstruction model is trained, the reconstruction speed when applying the trained model can be very fast. The deep-learning-based reconstruction technique can be applied to 3D imaging systems based on the disclosed metalens array configured with both the extended DOV and the bounded angular FOV to perform fast 3D object reconstructions.

Similar to the 2D imaging systems, the disclosed metalens array with extended DOV and bounded angular FOV for 3D imaging can be directly attached to the sample surface and camera sensor due to the absence of a main lens, thus achieving a compact 3D large FOV camera for microscopic imaging application. The specific metalens-sensor integration setups can be either of those discussed above in conjunction with FIGS. 8A and 8B. An exemplary design of a metalens array for 3D imaging has the following specifications: 5×5 metalens units with each metalens unit of size 1 mm×1 mm; an effective focal length of 1.75 mm; an object distance of 3.85 mm; and a distance between the sensor and metalens of 1.88 mm.

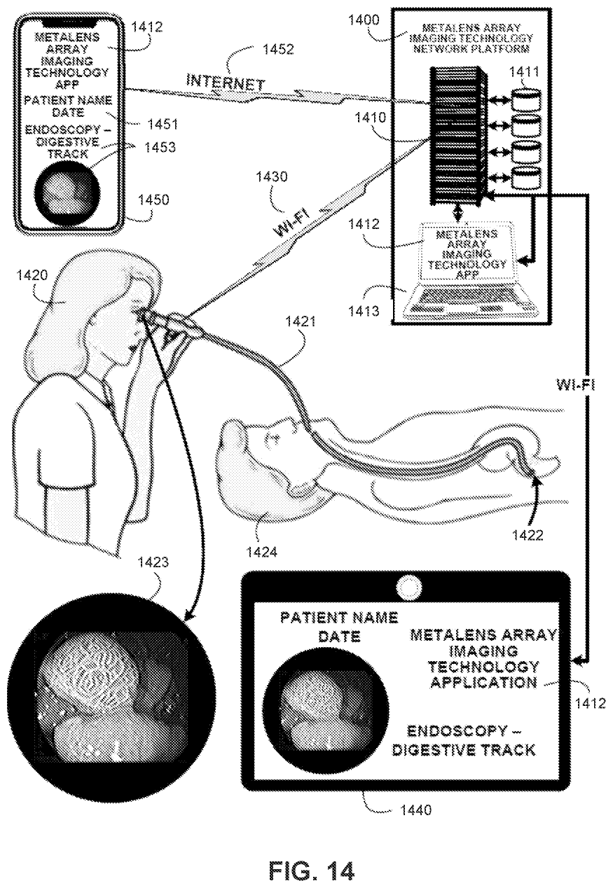

FIG. 14 shows an exemplary 3D imaging application of the disclosed metalens array having the extended DOV in an endoscope imaging system in accordance with the disclosed embodiments. Specifically, FIG. 14 shows a physician 1420 using an endoscope camera 1421 including a metalens array 1422 positioned at the distal end of the endoscope camera 1421 and composed of metalens units with a controllable or bounded angular FOV to view a potential condition 1423 in a patient digestive tract. The small-scale of the metalens-array endoscope camera reduces the footprint of the endoscope camera making the procedure for both the physician 1420 and patient 1424 less difficult for insertion and less uncomfortable.

The metalens-array endoscope camera (or “metalens-array camera”) is equipped with an electrical cable to transmit the images along the endoscope cable and provide a clear high-resolution image for the physician to determine a diagnosis. The metalens-array camera image is transmitted to a metalens array imaging technology network platform 1400 to be recorded in the patient's electronic medical records in a plurality of databases 1411 coupled to the platform servers.

A network computer with a metalens array imaging technology app 1412 is coupled to the network servers 1410 and automatically transmits the recorded database metalens array camera image(s) to a physician's tablet 1440 for later consultation with the patient 1424. The metalens array imaging technology network platform 1400 is also or instead used by the physician 1420 to transmit over the internet 1452 the metalens array camera image(s) to a specialist's smartphone 1450 for additional evaluation and a possible patient referral. In another exemplary application, the metalens device is attached to the brain surface of a mouse to monitor its brain activity. A long data transmission wire is connected to the metalens device so the mouse can run in an open field. This exemplary application is commonly performed in scientific research labs.

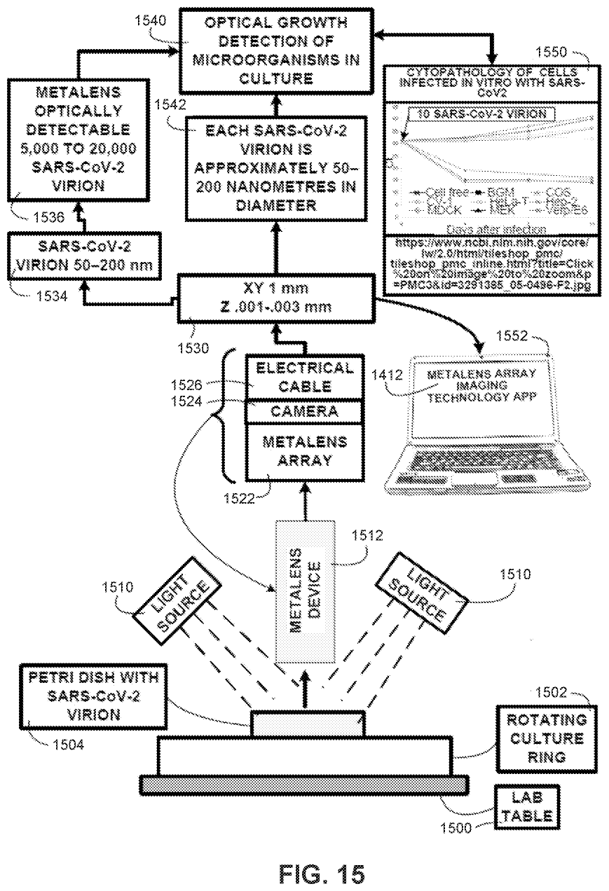

FIG. 15 shows an exemplary application of the disclosed metalens array in a metalens-based microscopy for imaging SARS-CoV2 in accordance with the disclosed embodiments. Specifically, FIG. 15 shows example results of the cytopathology of cells infected in vitro with SARS-CoV2 1550 indicating that it can take days to detect growth in SARS-CoV2 cells. Optical growth detection of microorganisms in culture 1540 is a common practice. Set on a lab table 1500 is typically a rotating culture ring 1502 populated with a number of a petri dish with SARS-CoV-2 virion 1504. One or more light sources 1510 illuminate the petri dish.

A metalens device 1512 and metalens array 1522 coupled with a camera 1524 capture the optically detectable cells and transmit the captured images through an electrical cable 1526 to a computer 1552 for recording in a database using the metalens array imaging technology app 1412. The metalens field of view is approximately 1 mm in both X and Y-directions, and 0.001-0.003 mm in Z-direction.

Each SARS-CoV-2 virion is approximately 50-200 nanometers in diameter. The metalens field of view 1530 and the size of a SARS-CoV-2 virion 1534 translate into the number of optically detectable SARS-CoV-2 virion by the metalens to be around 5,000-20,000. The nanoscale images generated by the metalens increase the ability for early detection of cell growth and reduce the time required to detect growth in cultures and speeds up the research.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. An metalens array for three-dimensional imaging, comprising:
an array of metalens units,
wherein each metalens unit in the array is configured with an extended depth of view (DOV) for projecting a cluster of object sources positioned in a range of object distances in the axial direction into a cluster of image spots in an image plane such that each of the image spots remains in focus and is separated from other image spots in the cluster of image spots; and
wherein the metalens array is configured to project the cluster of object sources into multiple clusters of image spots in the image plane, wherein each cluster of image spots is a different copy of the cluster of object sources in the image plane located apart from other clusters of image spots.

2. The metalens array of claim 1, wherein each metalens unit in the metalens array is configured with a phase-shift profile to effectuate a Bessel beam point spread function (PSF) in the image plane for each object source in an object plane within the extended DOV.

3. The metalens array of claim 2, wherein each metalens unit comprises:
a substrate support; and
an axicon structure disposed on the substrate support to effectuate the Bessel beam PSF for a given object source.

4. The metalens array of claim 2, wherein each metalens unit comprises:
a substrate support; and
a 2D array of nanostructures disposed on the substrate support to effectuate a spatial phase-shift profile that resembles an axicon.

5. The metalens array of claim 1, wherein each metalens unit in the metalens array includes a phase-shift mask to effectuate a double-helix PSF in the image plane for each object source in an object plane within the extended DOV.

6. The metalens array of claim 1, wherein each metalens unit in the metalens array includes a phase-shift mask to effectuate a cubic phase PSF in the image plane for each object source in an object plane within the extended DOV.

7. The metalens array of claim 1, wherein the metalens array is configured to allow only a predetermined number of metalens units within the metalens array to image an object point source into the predetermined number of image spots in the image plane, wherein the predetermined number is less than the number of metalens units in the metalens array, thereby limiting the total number of images of the object point source in the image plane.

8. The metalens array of claim 7, wherein the total number of clusters in the multiple clusters of image spots equals the predetermined number.

9. The metalens array of claim 7, wherein the predetermined number is between 4 and 9.

10. The metalens array of claim 7, wherein the predetermined number of metalens units includes either 2×2 metalens units or 3×3 metalens units.

11. The metalens array of claim 1, wherein each metalens unit within the metalens array units is configured with a bounded angular field of view (FOV) such that the metalens unit operates to pass an incident light emitted inside the bounded angular FOV of the metalens unit and reject an incident light beyond the bounded angular FOV of the metalens unit.

12. The metalens array of claim 11, wherein the metalens array has an overall two-dimensional (2D) FOV in an object plane determined by the sum of individual bounded angular FOVs associated with the individual metalens units in the metalens array.

13. The metalens array of claim 1, wherein the metalens array has a depth of view (DOV) in the axial direction that equals the extended DOV of the individual metalens units in the metalens array.

14. The metalens array of claim 1, wherein the array of metalens units includes M×N metalens units, wherein M≠N.

15. A metalens unit for three-dimensional (3D) imaging, wherein:
the metalens unit is configured with an extended depth of view (DOV) for projecting a cluster of object sources positioned in a range of object distances in the axial direction into a cluster of image spots in an image plane such that each of the image spots remains in focus and is separated from other image spots in the cluster of image spots; and
the metalens unit is further configured with a bounded angular field of view (FOV) such that the metalens unit operates to pass an incident light emitted inside the bounded angular FOV of the metalens unit and reject an incident light beyond the bounded angular FOV of the metalens unit.

16. The metalens unit of claim 15, wherein the metalens unit is configured with a phase-shift profile to effectuate a Bessel beam point spread function (PSF) in the image plane for each object source in an object plane within the extended DOV.

17. The metalens unit of claim 15, further comprising:
a substrate support; and
a 2D array of nanostructures disposed on the substrate support to effectuate a phase-shift profile that resembles an axicon.

18. The metalens unit of claim 15, wherein the metalens unit includes a phase-shift mask to effectuate a double-helix PSF in the image plane for each object source in an object plane within the extended DOV.

19. The metalens unit of claim 15, wherein the metalens unit includes a phase-shift mask to effectuate a cubic phase PSF in the image plane for each object source in an object plane within the extended DOV.

20. An metalens array for three-dimensional (3D) imaging, comprising:
an array of metalens units,
wherein each metalens unit in the array is configured with an extended depth of view (DOV) for projecting a cluster of object sources positioned in a range of object distances in the axial direction into a cluster of image spots in an image plane such that each of the image spots remains in focus and is separated from other image spots in the cluster of image spots;
wherein each metalens unit in the array is further configured with a bounded angular field of view (FOV) such that the metalens unit operates to pass an incident light emitted inside a predetermined cutoff angle of the bounded angular FOV and reject an incident light beyond the predetermined cutoff angle of the bounded angular FOV; and
wherein the metalens array generates only a predetermined number of copies of images for each object point source in an image plane.

21. The metalens array of claim 20, wherein the predetermined number is between 4 and 9.

22. The metalens array of claim 21, wherein the predetermined number is less than the number of metalens units in the metalens array, thereby limiting the total number of images of the object point source in the image plane.

23. The metalens unit of claim 20, wherein the metalens array has an overall two-dimensional (2D) FOV in an object plane determined by the sum of individual bounded angular FOVs associated with the individual metalens units in the metalens array.

24. The metalens array of claim 20, the array of metalens units includes M×N metalens units, wherein M≠N.

25. The metalens array of claim 20, the array of metalens units includes M×N metalens units, wherein M=N.

26. A method for imaging and resolving objects in a three-dimension (3D) space, comprising:
projecting, via a metalens array, a cluster of object sources within a 3D volume having different object distances in the axial direction of the metalens array into multiple clusters of image spots in an image plane of the metalens array,
wherein each cluster of image spots is a different copy of the cluster of object sources in the image plane located apart from other clusters of image spots in the image plane; and
wherein the metalens array is configured with an extended depth of view (DOV) so that each image spot within each cluster of image spots remains in focus and is separated from other image spots in the cluster of image spots; and
processing, using one or more processors, the multiple clusters of image spots using a ray-tracing technique to correlate each image spot in the multiple clusters of image spots to an object source in the cluster of object sources.

27. The method of claim 26, wherein processing the multiple clusters of image spots using a ray-tracing technique includes resolving two object sources having different Z-distances in the axial direction but similar in-plane positions by applying a scaling rule that:
an object point source having a greater Z distance in the axial direction is projected onto the image plane closer to the center of the image plane; and
an object point source having a smaller Z distance in the axial direction is projected onto the image plane further away from the center of the image plane.

28. The method of claim 26, wherein processing the multiple clusters of image spots using a ray-tracing technique includes resolving two object sources having different in-plane positions but similar Z-distances in the axial direction by applying a translation rule to each copy of the images of the two object sources in the multiple clusters of image spots.
